(19) United States
(12) Patent Application Publication
(10) Pub. No.: US 2026/0065807 A1
(43) Pub. Date: Mar. 5, 2026

(54) System and Method for Training and Assessing Cardiopulmonary Resuscitation Performance Based on Feedback

(71) Applicant: World Youth Heart Federation - India, Vadodara (IN)

(72) Inventors: Priyansh Shah, Armonk, NY (US); Varun Bharathi Jayakumar, Watertown, MA (US); Ajay Kaarthic Jeysree, Dallas, TX (US); Prem Kumar Raghava Manoharan, Austin, TX (US)

(21) Appl. No.: 19/308,994

(22) Filed: Aug. 25, 2025

Related U.S. Application Data
(60) Provisional application No. 63/687,764, filed on Aug. 27, 2024.

(51) Int. Cl. G09B 23/28; G01B 11/22; G06V 10/82; G06V 40/20

(52) U.S. Cl. CPC G09B 23/288; G01B 11/22; G06V 10/82; G06V 40/23

(57) ABSTRACT

A system and method for training, assessing, and providing feedback on cardiopulmonary resuscitation (CPR) performance based on at least one video of a CPR training session performed by a trainee on a non-mannequin training object. A preprocessing module is configured to process the at least one video to generate a standardized video. A marking module is configured to use pose estimation to mark points for body movements during the CPR training session based on the standardized video, and a computing module configured to compute body movement parameters for CPR based on the marked points. A classification module implements a machine learning model that classifies CPR compressions on the non-mannequin training object based on the computed body movement parameters, thereby generating compression classifications, wherein the machine learning model is trained to extract CPR-specific features. An editor module maps metrics over the standardized video based on the compression classifications and generates a feedback video based on the mapped metrics. An analysis module identifies deviations from CPR guidelines based on the feedback video and generates analysis results based on the deviations. A feedback module provides performance feedback to the trainee based on the analysis results.

### CROSS-REFERENCE TO RELATED APPLICATIONS

This application claims priority to U.S. Prov. App. No. 63/687,764, filed on Aug. 27, 2024, entitled, “System and Method for Training and Assessing Cardiopulmonary Resuscitation Performance Based on Feedback,” which is hereby incorporated by reference in its entirety.

### BACKGROUND

The background information herein below relates to the present disclosure but is not necessarily prior art.

More than 356,000 people experience out-of-hospital cardiac arrest annually in the United States, with a mortality rate of 60% to 80% before hospital arrival. Research indicates that bystander cardiopulmonary resuscitation (CPR) can significantly increase the chances of survival, potentially doubling or tripling them. Several organizations, including the American Heart Association, Red Cross, and Save a Life, offer both in-person and online CPR training courses under the Basic Life Support (BLS) and Advanced Cardiac Life Support (ACLS) programs. However, the current online courses primarily assess theoretical knowledge, failing to provide adequate practical skill evaluation. This limitation renders online courses insufficient as standalone methods for CPR certification.

Recent advancements have led to the development of e-learning tools, which utilize mannequins to detect compression rate, depth, recoil and hand positioning. However, these systems fail to provide comprehensive feedback on critical aspects of CPR performance, such as elbow angles and overall body posture. These systems require a virtual or an in-person trainer to assess the trainee's posture and technique, making the process both costly and cumbersome. The reliance on mannequins and virtual trainers also limits accessibility and scalability, particularly in remote or resource-limited settings. Consequently, there is a significant need for an innovative solution that offers comprehensive, real-time, and cost-effective assessment of CPR performance, integrating advanced video analysis and machine learning technologies to overcome these technical limitations.

Existing CPR training technologies include mannequins, wearable feedback devices, and basic mobile apps. Mannequins are expensive to perform the CPR trainings and thus making it challenging for some organizations and individuals to afford them. Some wearable devices are intended for emergencies, and the ones used for trainings are limited by their availability and cost. Mobile apps often measure limited aspects of effective CPR like the compression rate and rely on user self-assessment, lacking detailed analysis. Consequently, there is a significant need for an innovative solution that offers comprehensive, real-time, and cost-effective assessment of CPR performance, integrating advanced video analysis and machine learning technologies to overcome these technical limitations.

Therefore, there is felt a need for a system and a method for training and assessing CPR performance based on training feedback that alleviates the aforementioned drawbacks.

### SUMMARY

Embodiments of the present invention provide a system and method for training, assessing, and providing feedback on cardiopulmonary resuscitation (CPR) performance using video analysis and machine learning technologies. The system may analyze video recordings of CPR training sessions performed on non-mannequin training objects, such as partially filled bottles, to evaluate trainee performance without requiring expensive mannequins or in-person instructors. The system may use pose estimation techniques to identify body movements, compute performance parameters, and classify CPR compressions as correct or incorrect using a trained machine learning model. The system may generate feedback videos with visual annotations and provide real-time performance analysis to help trainees improve their CPR techniques.

Embodiments of the system may offer several advantages over existing CPR training approaches. The system may provide cost-effective training by eliminating the need for expensive mannequins and reducing reliance on in-person instructors. The system may offer improved accessibility by enabling CPR training in remote or resource-limited settings where traditional training equipment may not be available. The system may deliver comprehensive performance analysis by evaluating multiple CPR parameters simultaneously, including compression depth, rate, hand positioning, and body posture, which may achieve greater than 95% accuracy in compression detection and 96% consistency with expert human evaluation in some embodiments. The system may provide objective and consistent assessment criteria through automated video analysis, reducing human bias in performance evaluation. The system may enable scalable training solutions that can accommodate large numbers of trainees simultaneously. The system may offer personalized feedback tailored to individual trainee performance weaknesses and improvement areas. The system may support multiple processing modes including post-recording analysis for detailed assessment and real-time feedback for immediate technique correction, providing deployment flexibility across different technical environments and user requirements.

In some embodiments, the system for training, assessing, and providing feedback on CPR performance may be based on at least one video of a CPR training session performed by a trainee on a non-mannequin training object. The system may include a preprocessing module configured to process the at least one video to generate a standardized video. The system may include a marking module configured to use pose estimation to mark points for body movements during the CPR exercise based on the standardized video. The system may include a computing module configured to compute body movement parameters for CPR based on the marked points. The system may include a classification module configured to implement a machine learning model that classifies CPR compressions on the non-mannequin training object based on the computed body movement parameters, thereby generating compression classifications, wherein the machine learning model may be trained to extract CPR-specific features. The system may include an editor module configured to map metrics over the standardized video based on the compression classifications and generate a feedback video based on the mapped metrics. The system may include an analysis module configured to identify, based on the feedback video, deviations from CPR guidelines and generate analysis results based on the deviations. The system may include a feedback module configured to provide performance feedback to the trainee based on the analysis results.

According to other aspects of the present disclosure, the system may include one or more of the following features. The non-mannequin training object may comprise a partially filled bottle. The system may further comprise a capturing device configured to capture the at least one video. The system may be configured to analyze the at least one video in real-time during the CPR training session. The capturing device may be further configured to record the at least one video, and the system may be configured to analyze the recorded at least one video. The preprocessing module may be configured to apply frame rate conversion to the at least one video to generate the standardized video with a consistent frame rate. The preprocessing module may be configured to apply background subtraction techniques to isolate the trainee from the background in the at least one video.

The marking module may be configured to identify key anatomical landmarks including at least one of shoulder joints, elbow joints, wrist joints, hip position, leg position, back position, or hand positions of the trainee. The marking module may be configured to detect and mark compression phases by identifying vertical displacement patterns of hand positions relative to the non-mannequin training object. The marking module may be configured to identify compression cycles by detecting periodic patterns in the marked point movements. The marking module may be configured to mark additional reference points on the non-mannequin training object to establish spatial relationships for depth measurements.

The computing module may be configured to calculate compression depth by measuring vertical displacement of hand positions relative to a baseline position on the non-mannequin training object. The computing module may be configured to determine compression rate by counting the number of compression cycles per minute based on the marked points. The computing module may be configured to compute hand positioning accuracy by measuring lateral displacement of hand positions from a target compression zone on the non-mannequin training object. The computing module may be configured to calculate elbow angle measurements during compression phases to assess arm positioning compliance with CPR guidelines. The computing module may be configured to determine compression release completeness by analyzing the return trajectory of hand positions between compression cycles. The computing module may be configured to compute body posture metrics by analyzing alignment of shoulder, hip, and knee joint positions relative to the non-mannequin training object. The computing module may be configured to calculate compression consistency by measuring variance in compression depth and timing across multiple compression cycles. The computing module may be configured to compute compression force estimation based on deformation characteristics of the non-mannequin training object captured in the at least one video.

The classification module may be configured to implement a convolutional neural network trained on a dataset of labeled CPR compression videos to distinguish between correct and incorrect compression techniques. The classification module may be configured to classify compressions into multiple categories including adequate depth, inadequate depth, correct hand placement, incorrect hand placement, correct body posture, incorrect body posture, appropriate rate, inappropriate rate, proper release, and incomplete release. The machine learning model may be trained using transfer learning from a pre-trained pose estimation model and fine-tuned on CPR-specific training data. The classification module may be configured to adapt the machine learning model based on real-time feedback from the trainee to personalize the classification criteria. The classification module may be configured to extract temporal features from sequences of body movement parameters to identify patterns indicative of proper CPR rhythm and timing. The classification module may be configured to weight different body movement parameters based on their relative importance to CPR effectiveness as determined during model training. The classification module may be configured to generate intermediate classifications for individual compression components and combine them to produce an overall compression quality score.

The editor module may be configured to overlay visual indicators on the feedback video to highlight correct and incorrect compression techniques in real-time. The editor module may be configured to generate color-coded annotations on the feedback video, wherein different colors represent different performance metrics. The editor module may be configured to embed numerical performance scores directly onto frames of the feedback video corresponding to specific compression events. The editor module may be configured to create side-by-side comparison views in the feedback video showing the trainee's performance alongside reference technique demonstrations. The editor module may be configured to generate slow-motion segments in the feedback video for detailed analysis of specific compression techniques. The editor module may be configured to embed corrective instruction prompts at specific timestamps in the feedback video corresponding to identified technique errors.

The analysis module may be configured to generate performance trend reports by comparing body movement parameters across multiple CPR training sessions to identify improvement patterns and areas requiring continued focus. The analysis module may be configured to calculate deviation scores by quantifying differences between the trainee's performance and established CPR guideline benchmarks for each body movement parameter. The analysis module may be configured to generate personalized training recommendations based on the trainee's specific performance weaknesses identified through statistical analysis of the deviations. The analysis module may be configured to identify critical failure points by analyzing sequences of body movement parameters that consistently lead to incorrect compression classifications.

The feedback module may be configured to generate real-time audio prompts during the CPR training session to guide the trainee through proper compression technique based on the analysis results. The feedback module may be configured to generate personalized coaching messages tailored to the trainee's specific performance weaknesses identified in the analysis results. The feedback module may be configured to implement adaptive feedback intensity that adjusts the level of guidance based on the trainee's skill progression over multiple training sessions.

### BRIEF DESCRIPTION OF THE DRAWINGS

FIG. 1 is a diagram of a system for assessing cardiopulmonary resuscitation (CPR) performance based on training feedback in accordance with an embodiment of the present disclosure;

FIGS. 2A and 2B illustrate a flow chart depicting a method for assessing cardiopulmonary resuscitation (CPR) performance based on training feedback in accordance with an embodiment of the present disclosure; and

FIG. 3 illustrates a flow chart depicting a method for training, assessing, and providing feedback on cardiopulmonary resuscitation (CPR) performance using video analysis in accordance with an embodiment of the present disclosure.

### DETAILED DESCRIPTION

Embodiments of the present disclosure will now be described with reference to the accompanying drawings.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units, and/or components, but do not forbid the presence or addition of one or more other features, elements, components, and/or groups thereof.

More than 356,000 people experience out-of-hospital cardiac arrest annually in the United States, with a mortality rate of 60% to 80% before hospital arrival. Research indicates that bystander CPR can significantly increase the chances of survival, potentially doubling or tripling them. Several organizations, including the American Heart Association, Red Cross, and Save a Life, offer both in-person and online CPR training courses under the Basic Life Support (BLS) and Advanced Cardiac Life Support (ACLS) programs. However, the current online courses primarily assess theoretical knowledge, failing to provide adequate practical skill evaluation. This limitation renders online courses insufficient as standalone methods for CPR certification.

Recent advancements have led to the development of e-learning tools by these organizations, which utilize mannequins to detect compression rates. These tools require a virtual trainer to assess the trainee's skills, making the process both costly and cumbersome. Additionally, these systems often fail to provide comprehensive feedback on critical aspects of CPR performance, such as compression depth, number of compressions per minute, hand positioning, elbow angles, and overall body posture. The reliance on mannequins and virtual trainers also limits accessibility and scalability, particularly in remote or resource-limited settings. Consequently, there is a significant need for an innovative solution that offers comprehensive, real-time, and cost-effective assessment of CPR performance, integrating advanced video analysis and machine learning technologies to overcome these technical limitations.

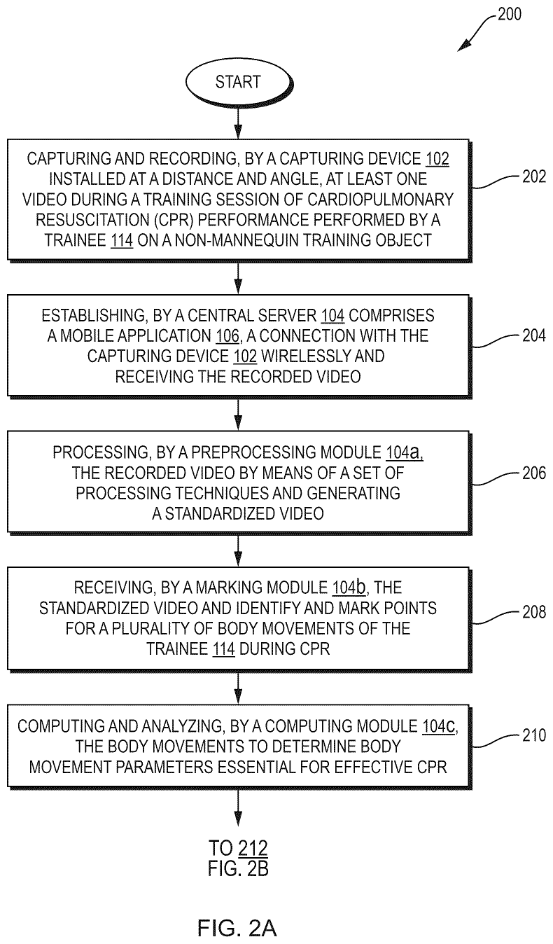

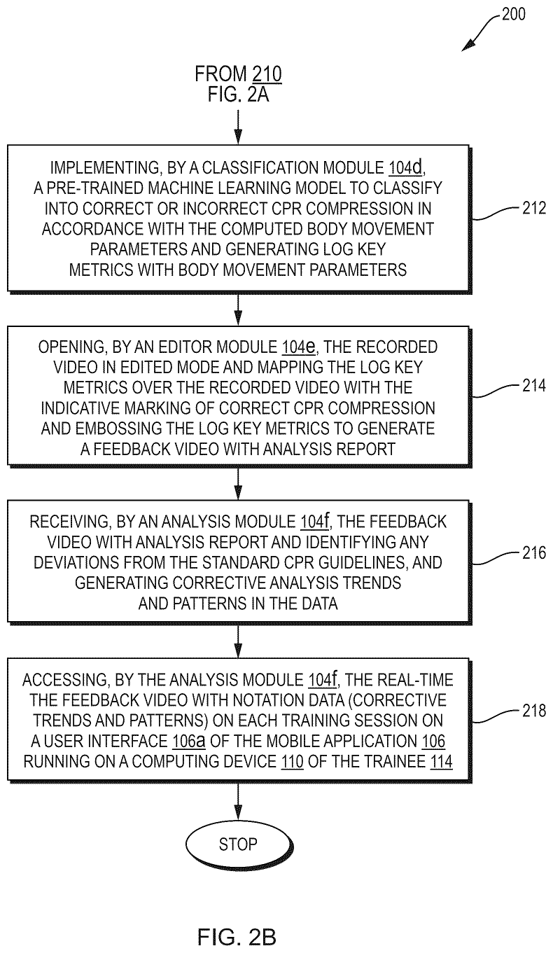

To overcome the aforementioned drawbacks, the present disclosure envisages a system 100 and a method 200 for training and assessing CPR performance based on training feedback. The system 100 is now being described with reference to FIGS. 2A and 2B.

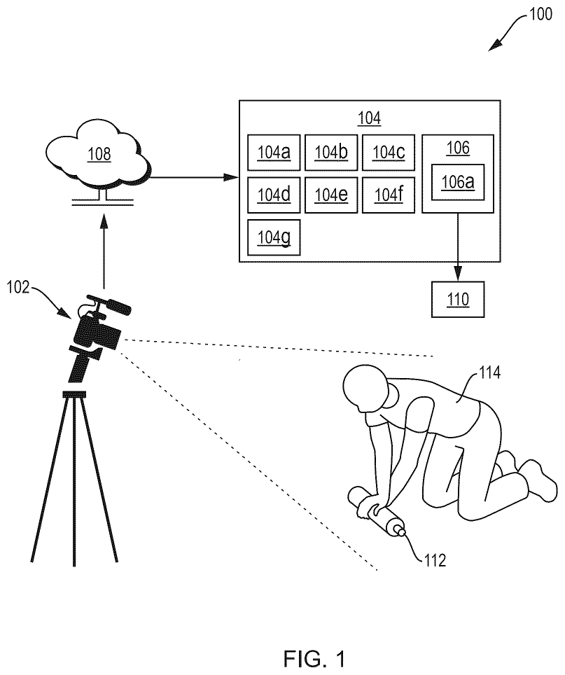

FIG. 1 illustrates a block diagram of a system 100 for assessing CPR performance based on training feedback in accordance with an embodiment of the present disclosure. The system 100 comprises a capturing device 102, a central server 104, and a mobile application 106.

The capturing device 102 may be positioned at various distances and angles relative to the training area. In some embodiments, the capturing device 102 may be positioned at a predefined distance and angle to capture and record at least one video during a training session of CPR performance performed by a trainee 114 on a mannequin/non-mannequin training object 112. Other types of capturing devices may be used.

In an embodiment, the training object 112 is a partially filled bottle which is filled with the desired amount of water, fluid material, or sealant, so a real-time CPR session is operated.

The system 100 may use other types of mannequin/non-mannequin training object 112 for training sessions which may include but not limited to CPR Pillows, mannequins, Compression Practice Pads, CPR Dummies, CPR Training Vests, Chest Compression Boards, and DIY Props items like rolled-up towels, cushions, or homemade dummies made from household materials can be used for basic compression practice.

The capturing device 102 is selected from a group of devices consisting of but not limited to analog and digital video cameras, digital still cameras, video frame grabbers, Single-lens reflex (SLR) cameras, motion picture cameras, mobile devices, tablet, peripheral device, or any electronic device capable of recording video.

The central server 104 comprises a mobile application 106 and establishes a connection with the capturing device 102 wirelessly by means of a wireless communication network 108 and receives the recorded video. Other types of servers may be used.

The central server 104 further comprises a preprocessing module 104a, a marking module 104b, a computing module 104c, a classification module 104d, an editor module 104e, and an analysis module 104f.

The central server 104 is selected from a group of servers consisting of but not limited to a central server, distributed server, remote server, blockchain-based server, standalone server, or any server capable of handling the operations.

The preprocessing module 104a is configured to receive the recorded video and process the recorded video by means of a set of processing techniques and generate a standardized video. Other types of preprocessing modules may be used.

The marking module 104b is configured to cooperate with the preprocessing module 104a to receive the standardized video and identify and mark points for a plurality of body movements of the trainee 114 during the CPR exercise. Other types of marking modules may be used.

The computing module 104c is configured to cooperate with the marking module 104b to compute and analyze the body movements to determine body movement parameters essential for effective CPR. Other types of computing modules may be used.

The plurality of body movements includes body the position of the hand, rate of compressions (e.g., number of compressions per minute), depth of compressions, elbow angle, shoulder, and torso. Typically the body landmarks and pose estimation are determined using a library such as OpenPose, Mediapipe, DeepLabCut, or customised pose estimation model. The customised pose estimation models aim at enhancing the reliability of the system of the present invention future.

The classification module 104d is configured to cooperate with the computing module 104c to implement a pre-trained machine learning model to classify into correct or incorrect CPR compression in accordance with the computed body movement parameters and further configured to generate log key metrics with body movement parameters. Other types of classification modules may be used. The pre-trained machine learning model improves the accuracy of prediction and classification of CPR compression as correct or incorrect by determining body movement parameters from the recorded video of each training session.

The pre-trained machine learning model accurately measures the number of compressions per minute and calculates the depth of each chest compression, body posture, and/or recoil.

The editor module 104e is configured to cooperate with the classification module 104d to open the recorded video in editable mode and the map the log key metrics over the recorded video with the indicative marking of correct CPR compression and emboss the log key metrics to generate feedback video with the analysis report. Other types of editor modules may be used.

The analysis module 104f is configured to cooperate with the editor module 104e to receive the feedback video with the analysis report and identify any deviations from the standard CPR guidelines, and further configured to generate corrective analysis trends and patterns in the data.

The analysis module 104f is further configured to access real-time feedback video with notation data (corrective trends and patterns) on each training session on a user interface 106a of the mobile application 106 running on a computing device 110 of the trainee 114. Other types of analysis modules may be used.

In an embodiment, the same device may be used to capture and record video during a training session and provide feedback.

The mobile application 106 provides real-time feedback on their performance based on the pre-trained machine learning model analysis, offering corrective advice and instructional support.

The computing device 110 is selected from a group of devices consisting of a mobile device, tablet, laptop, desktop, remote device, or any device capable of accessing the feedback video.

In an embodiment, the system 100 comprises a data aggregation module 104g configured to store a predefined dataset containing correct and incorrect CPR compressions with labels and further configured to receive and store recorded training videos CPR training sessions, and CPR training videos from one or more medical repositories of the training institute, hospitals, remote servers, and social platform. Other types of data aggregation modules may be used.

In an embodiment, the data aggregation module 104g is configured to securely store CPR guidelines, training session videos, feedback videos, and analysis reports.

In an embodiment, the system comprises a reward module configured to generate the reward points for the trainee after the completion of each individual training session, wherein the reward points are calculated based on the analysis of scores of previous training sessions, real-time feedback, and current training sessions.

The completion certificate with reward points is generated for each trainee after assessing the CPR performance of the trainee based on training feedback.

In an embodiment, the system may be configured with a social platform where the trainee shares his/her completion certificate on at least one social platform account.

In an embodiment, the pre-trained machine learning model is configured to:
receive the dataset containing correct and incorrect CPR compressions with labels;
compute body movement parameters for each training session, such as hand position, number of compressions per minute, compression depth, compression rate (e.g., number of compressions per minute), and body position;
normalize and preprocess the data to ensure consistency and to prepare for model input;
extract relevant features from the body movement parameters that are indicative of correct or incorrect CPR compressions, wherein features include:
   tracking of the vertical position of hands over time, identifying peaks and troughs in the hand position to determine the number of compressions per minute;
   calculate the angle between the shoulder, elbow, and wrist using the key points detected by the pose estimation model and tracking the angle over to monitor the bending of the elbows;
   calculate the hand positioning of the trainee to monitor the hand displacement measure the vertical displacement of the hands relative to a fixed body part, like the shoulder or torso, to estimate compression depth and number of compressions per minute; and
   analyze the positions of the head, shoulders, back and hips to assess the overall posture, and ensure that the body posture is consistent with proper CPR technique (e.g., straight arms with locked elbows, correct body alignment).
   selection of machine learning model for classification;
   split the dataset into training, validation, and test sets;
   train the selected model on the training set, using the validation set to tune hyperparameters and prevent overfitting;
   evaluate the selected model's performance on the test set to ensure it generalizes well to unseen data and further perform cross-validation to assess the selected model's stability and robustness, wherein the evaluation includes matrices consisting of accuracy, precision, recall, and F1-score; and
   using a trained model to classify new CPR compression data from each recorded video of the training session into correct or incorrect, wherein the pre-trained machine learning model is an iterative model each prediction includes log key metrics and classification results.

In an embodiment, the body movement parameters include mark points of the body movement, hand positioning, compression rate (e.g., number of compressions per minute), body pressure, elbow angle, depth of CPR compression, and count of CPR compression.

In an embodiment, the system 100 is configured to record parameters like ventilation rate and rescuer fatigue levels.

In an embodiment, the set of processing techniques is used to analyze, enhance, and transform video content.

In an embodiment, the set of processing techniques is selected from a group of techniques consisting of frame differencing, background subtraction, object detection and tracking, noise reduction, resolution enhancement, Frame Rate Conversion, Color Correction and Grading, Face Detection and Recognition, Gesture Recognition, Scene Detection, Video Summarization, Augmented Reality (AR), Video Inpainting, Temporal Filtering, Deep Learning-Based Techniques, and Content-Based Video Retrieval (CBVR).

In an embodiment, the capturing device 102 is installed in accordance with adjusted hand positioning, compression rate, elbow angle, number of compressions per minute, and compression depth.

In an embodiment, the classification module 104d accurately classifies correct or incorrect CPR compression in accordance with the previously stored feedback video with notation data (corrective trends and patterns) and the computed body movement parameters.

In an embodiment, the system 100 is configured to integrate gamification elements to make training sessions more engaging in real-time.

In an exemplary embodiment, the trainee begins by setting up the capturing device 102 at, for example, the predefined distance and angle relative to the training area where they will perform CPR on a partially filled bottle 112. This precise setup ensures that the device captures optimal video footage of the entire CPR training session, focusing on the key body movements essential for effective CPR performance.

During the training session, the capturing device 102 records the trainee's CPR performance. The trainee performs CPR compressions on the partially filled bottle 112, simulating a real-life scenario. The captured video is then wirelessly transmitted to the central server 104 via the wireless communication network 108, ensuring seamless and efficient data transfer for further analysis.

Once the central server 104 receives the recorded video, the preprocessing module 104a processes it to generate a standardized version. This step is crucial for ensuring consistency and accuracy in subsequent analyses. The marking module 104b then identifies and marks key points of the trainee's body movements during the CPR exercise. These marked points are analysed by the computing module 104c, which determines essential body movement parameters such as compression rate, number of compressions per minute, depth, elbow angle, and body posture.

The classification module 104d utilizes a pre-trained machine learning model to classify the CPR compressions as correct or incorrect based on the computed body movement parameters. It generates logs of key metrics, including detailed body movement parameters, providing a comprehensive overview of the trainee's performance.

The editor module 104e plays a pivotal role in enhancing the trainee's understanding of their performance. It opens the recorded video in an editable mode and maps the log key metrics over the video. Correct CPR compressions are marked, and the log key metrics are embossed onto the video, resulting in a feedback video with an analysis report. This visual and detailed feedback helps the trainee easily identify areas needing improvement.

The analysis module 104f reviews the feedback video and analysis report, identifying any deviations from standard CPR guidelines. It generates corrective analysis trends and patterns, which are then accessible to the trainee in real-time through the mobile application 106 running on their computing device 110. This real-time feedback is crucial for immediate correction and learning.

The trainee accesses the feedback video and analysis report on their computing device 110 via the user-friendly interface of the mobile application 106. The application provides detailed feedback, including corrective trends and patterns, allowing the trainee to understand their mistakes and areas for improvement. Guided by this real-time feedback and detailed analysis, the trainee can review their performance and make necessary adjustments in subsequent training sessions.

The mobile application 106 is further configured to:
Step 1: Design the user interface (UI) focusing on ease of use and intuitive navigation;
Step 2: Integrate video recording functionality to capture CPR sessions;
Step 3: Implement real-time feedback features to display corrective advice based on the algorithm's analysis; and
Step 4: Develop instructional support modules to guide users in improving their CPR techniques.

The system 100 is further configured to perform testing and validation:
Step 1: Conduct extensive testing of the mobile application and backend infrastructure;
Step 2: Validate the accuracy and effectiveness of the algorithm in providing real-time feedback; and
Step 3: Gather user feedback to refine and improve the system.

The system 100 is further configured to perform:
Step 1: Set up cloud-based servers to handle video processing and analysis;
Step 2: Implement data storage solutions to securely store user videos and analysis results;
Step 3: Integrate the algorithm with the backend to process videos and generate feedback; and
Step 4: Ensure scalability and reliability to handle a large number of users simultaneously.

In an exemplary embodiment, the present disclosure provides a method for assessing cardiopulmonary resuscitation (CPR) performance based on training feedback.
capturing and recording, by a capturing device 102 installed at, for example, a predefined distance and angle, at least one video during a training session of cardiopulmonary resuscitation (CPR) performance performed by a trainee 114 on a CPR subject mannequin or other CPR object 112;
establishing, by a central server 104 comprises a mobile application 106, a connection with the capturing device 102 wirelessly and receiving the recorded video;
processing, by a preprocessing module 104a, the recorded video by means of a set of processing techniques and generating a standardized video;
receiving, by a marking module 104b, the standardized video and identify and mark points for a plurality of body movements of the trainee 114 during CPR exercise;
computing and analyzing, by a computing module 104c, the body movements to determine body movement parameters essential for effective CPR;
implementing, by a classification module 104d, a pre-trained machine learning model to classify into correct or incorrect CPR compression in accordance with the computed body movement parameters and generating log key metrics with body movement parameters;
opening, by an editor module 104e, the recorded video in editable mode and mapping the log key metrics over the recorded video with the indicative marking of correct CPR compression and embossing the log key metrics to generate a feedback video with analysis report;
receiving, by an analysis module 104f, the feedback video with analysis report and identifying any deviations from the standard CPR guidelines, and generating corrective analysis trends and patterns in the data, and
accessing, by the analysis module 104f, the real-time the feedback video with notation data (corrective trends and patterns) on each training session on a user interface 106a of the mobile application 106 running on a computing device 110 of the trainee 114.

FIGS. 2A and 2B illustrate a flow chart depicting steps involved in the method 200 for assessing cardiopulmonary resuscitation (CPR) performance based on training feedback in accordance with an embodiment of the present disclosure.

At step 202, the method 200 includes capturing and recording, by a capturing device 102 installed, for example, at a predefined distance and angle, at least one video during a training session of cardiopulmonary resuscitation (CPR) performance performed by a trainee 114 on a CPR subject mannequin or other CPR object 112 (e.g., partially filled bottle).

At step 204, the method 200 includes establishing, by a central server 104 comprising a mobile application 106, a connection with the capturing device 102 wirelessly and receiving the recorded video.

At step 206, the method 200 includes processing, by a preprocessing module 104a, the recorded video by means of a set of processing techniques and generating a standardized video.

At step 208, the method 200 includes receiving, by a marking module 104b, the standardized video and identifying and marking points for a plurality of body movements of trainee 114 during CPR exercise.

At step 210, the method 200 includes computing and analyzing, by a computing module 104c, the body movements to determine body movement parameters essential for effective CPR.

At step 212, the method 200 includes implementing, by a classification module 104d, a pre-trained machine learning model to classify into correct or incorrect CPR compression in accordance with the computed body movement parameters and generating log key metrics with body movement parameters.

At step 214, the method 200 includes opening, by an editor module 104e, the recorded video in editable mode and mapping the log key metrics over the recorded video with the indicative marking of correct CPR compression and embossing the log key metrics to generate a feedback video with analysis report.

At step 216, the method 200 includes receiving, by an analysis module 104f, the feedback video with an analysis report and identifying any deviations from the standard CPR guidelines and generating corrective analysis trends and patterns in the data.

At step 218, the method 200 includes accessing, by the analysis module 104f, the real-time the feedback video with notation data (corrective trends and patterns) on each training session on a user interface 106a of the mobile application 106 running on a computing device 110 of the trainee 114.

Advantageously, the system 100 provides pre-trained machine learning model for precise measurements of key CPR parameters, including compression rate, number of compressions per minute, depth, hand positioning, and elbow angle. This high level of accuracy ensures that users receive detailed and reliable feedback. The mobile application 106 provides immediate corrective advice during CPR training sessions, allowing users to adjust their technique on the spot. By leveraging mobile application 106, system 100 makes high-quality CPR training available to anyone with a smartphone, eliminating the need for expensive equipment and physical presence in a training center. Further, it reduces the overall cost of CPR training by eliminating the need for specialized hardware and physical training sessions. The use of central server 104 infrastructure is designed to handle a large number of users simultaneously, ensuring consistent performance and availability. The system 100 provides detailed analysis and feedback on multiple CPR parameters, ensuring a well-rounded training experience. The instructional support and corrective advice provided by the mobile application 106 help users to understand their mistakes and learn the correct techniques more effectively. Users can practice CPR training at their convenience, without the need for scheduled sessions or specific locations.

The functions described herein may be implemented in hardware, software executed by a processor, firmware, or any combination thereof. If implemented in software executed by a processor, the functions may be stored on or transmitted over as one or more instructions or codes on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

The foregoing description of the embodiments has been provided for purposes of illustration and is not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

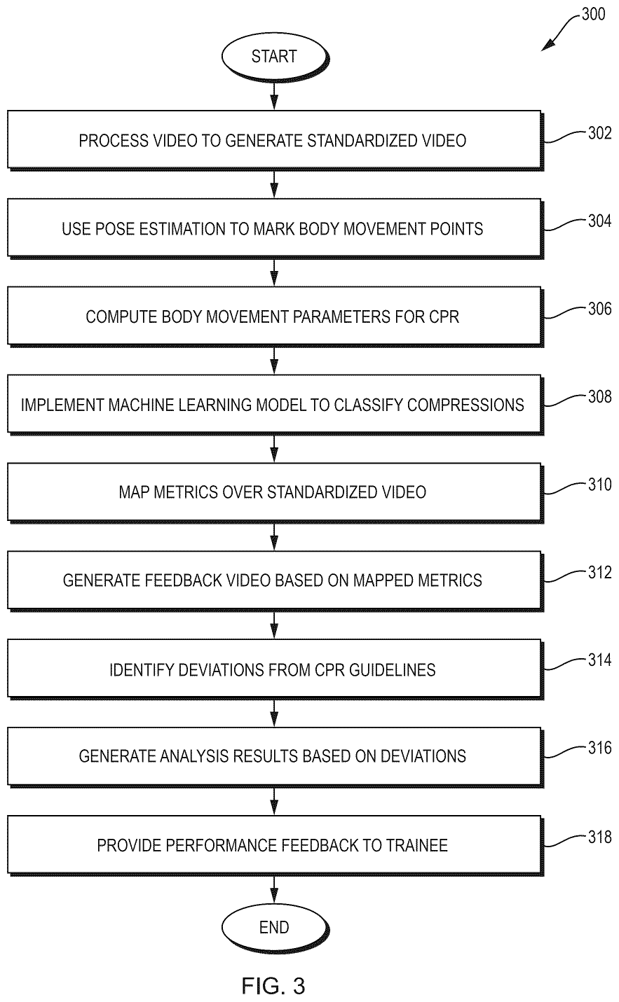

Referring to FIG. 3, an embodiment of the present invention is directed to a method 300 for training, assessing, and providing feedback on cardiopulmonary resuscitation (CPR) performance using video analysis of a CPR training session. The method 300 begins at step 300 and utilizes the system 100 components shown in FIG. 1 to analyze video recordings of a trainee 114 performing CPR on a non-mannequin training object, such as a partially filled bottle or other substitute training device.

The method 300 proceeds through step 302, where the preprocessing module 104a processes at least one video of the CPR training session to generate a standardized video with consistent formatting and quality. At step 304, the marking module 104b employs pose estimation techniques to identify and mark specific points corresponding to the trainee's body movements during the CPR exercise, focusing on anatomical landmarks that are relevant to proper CPR technique. The computing module 104c then calculates body movement parameters for CPR based on these marked points at step 306, determining metrics such as compression depth, hand positioning, compression rate, and body posture alignment.

Moving to step 308, the classification module 104d implements a machine learning model that has been specifically trained to extract CPR-specific features from the computed body movement parameters. This machine learning model classifies individual CPR compressions performed on the non-mannequin training object as either correct or incorrect, generating compression classifications that reflect adherence to established CPR guidelines. At step 310, the editor module 104e maps performance metrics over the standardized video based on these compression classifications, creating visual annotations that highlight areas of proper and improper technique.

The method 300 continues at step 312, where the editor module 104e generates a comprehensive feedback video that incorporates the mapped metrics, providing visual cues and performance indicators overlaid on the original training footage. At step 314, the analysis module 104f examines the feedback video to identify specific deviations from established CPR guidelines, comparing the trainee's performance against standardized benchmarks. The analysis module 104f then generates detailed analysis results based on these identified deviations at step 316, creating personalized assessments that highlight areas for improvement.

Finally, at step 318, a feedback module provides performance feedback to the trainee 114 based on the analysis results, delivering actionable insights through the mobile application 106 and user interface 106a on the computing device 110. The method 300 concludes at step, having completed a full cycle of video capture, analysis, and feedback delivery. This embodiment of the present invention may enable comprehensive CPR training assessment without requiring expensive mannequins or in-person instructors, making quality CPR education more accessible and cost-effective while maintaining objective evaluation standards.

Embodiments of the system 100 may implement and receive the at least one video of the CPR training session in various configurations and formats to accommodate different training environments and technical requirements. The video capture and delivery mechanisms may be adapted to support diverse training scenarios while maintaining the analytical capabilities of the system 100. The system 100 may utilize either single video recordings that capture the entire CPR training session from a fixed perspective or multiple videos captured simultaneously from different angles to provide comprehensive coverage of the trainee's 114 technique and body positioning.

The capturing device 102 may be positioned, for example, at a predetermined distance and angle relative to the trainee 114 and the non-mannequin training object to ensure optimal visibility of body movements and compression techniques. For multi-camera implementations, the system 100 may receive video from multiple capturing devices 102 positioned at various locations around the training area, such as overhead views, side views, and frontal perspectives, to capture different aspects of the trainee's 114 technique and body positioning. The video implementation may vary in terms of temporal characteristics and delivery methods, supporting both real-time streaming and stored video processing approaches.

For real-time applications, the system 100 may process live video streams transmitted from the capturing device 102 to the central server 104 through the wireless communication network 108, enabling immediate analysis and feedback during the CPR training session. The live video stream may be transmitted using various streaming protocols and may include adaptive bitrate streaming to accommodate different network conditions and bandwidth limitations. Alternatively, embodiments of the system 100 may work with stored video recordings that are captured and saved locally on the capturing device 102 before being transmitted to the central server 104 for analysis. The stored video approach may provide advantages in situations where network connectivity is intermittent or where the training session needs to be reviewed multiple times, with transmission occurring immediately after recording or at a later time when network conditions are favorable.

Video capture initiation and control may be implemented through different mechanisms depending on the specific implementation. The capturing device 102 may begin recording automatically when the trainee 114 enters the training area or when motion is detected, or may require manual initiation through the mobile application 106 or through controls on the capturing device 102 itself. The duration of video capture may vary based on the training protocol, ranging from short segments focusing on specific compression sequences to extended recordings covering complete CPR training sessions. The capturing device 102 may record video at various resolutions, frame rates, and compression levels depending on the analytical requirements and available storage or transmission capacity, with higher resolution video providing more detailed analysis of hand positioning and body movements, while lower resolution video may be sufficient for basic compression rate and rhythm assessment.

The system 100 may be configured to work with standard video formats such as MP4, AVI, or MOV, and may include format conversion capabilities to ensure compatibility with the preprocessing module 104a. Video reception and handling by the central server 104 may involve various buffering and queuing mechanisms to manage multiple concurrent training sessions, with the central server 104 receiving and processing videos from multiple trainees 114 simultaneously through efficient resource allocation and processing prioritization. The system 100 may implement video preprocessing steps immediately upon reception, such as format standardization, quality enhancement, or preliminary motion detection, to prepare the video for subsequent analysis by the marking module 104b and other processing components.

Embodiments of the system 100 may utilize a wide variety of non-mannequin training objects that serve as substitutes for traditional CPR mannequins while providing effective training platforms for compression technique assessment. These non-mannequin training objects may offer several advantages over conventional mannequins, including reduced cost, increased accessibility, and enhanced portability for training in diverse environments. As used herein, the term “non-mannequin training object” may refer to any substitute object used for CPR compression training that is not a traditional CPR mannequin or medical training mannequin. The system 100 may incorporate bottle detection and calibration capabilities that utilize convolutional neural network (CNN) based regression models to automatically recognize bottle types, estimate fill levels, and calibrate object-specific assessment criteria. The CNN-based bottle recognition system may be trained on datasets containing images of various transparent plastic bottles filled with different water volumes under diverse lighting and background conditions, enabling accurate bottle type classification and fill level estimation ranging from approximately 65% to 75% when water reaches the top edge of bottle wrappers. The non-mannequin training objects may be characterized by their ability to provide tactile feedback during compression exercises while being sufficiently visible in video recordings to enable accurate pose estimation and movement analysis by the marking module 104b, and by their ability to deform under applied pressure and return to their original shape, simulating the resistance and feedback experienced during actual chest compressions.

Non-mannequin training objects may include, for example, household items, everyday objects, and/or repurposed materials that provide a compressible surface suitable for practicing chest compression techniques. These objects may include, but are not limited to, partially filled bottles, cushions, pillows, rolled towels, foam blocks, inflatable items, cardboard boxes with filling materials, fabric-based objects, exercise equipment, books, magazines, clothing items, and/or any other readily available item that can serve as a training platform for CPR compression practice. The non-mannequin training objects may be selected based on their compressibility characteristics, dimensional properties, visual contrast for video analysis, availability, cost-effectiveness, and/or cultural accessibility, while providing sufficient tactile feedback to enable effective CPR skill development without requiring specialized medical training equipment.

Referring to FIG. 1, the training dummy 112 represents one example of a non-mannequin training object that may be employed in various embodiments of the system 100. The system 100 may implement object-specific calibration algorithms that automatically adjust assessment parameters based on the detected training object characteristics, utilizing machine learning models trained to recognize bottle geometry, material properties, and fill levels. Partially filled bottles may serve as particularly effective non-mannequin training objects due to their compressible nature and widespread availability. The bottles may be filled with varying amounts of water, sand, rice, and/or other materials to achieve different compression resistance levels that simulate the feel of chest compressions on a human torso.

Referring to FIG. 1, the training dummy 112 represents one example of a non-mannequin training object that may be employed in various embodiments of the system 100. The system 100 may implement object-specific calibration algorithms that automatically adjust assessment parameters based on the detected training object characteristics, utilizing machine learning models trained to recognize bottle geometry, material properties, and fill levels. In some embodiments, the system 100 may utilize CNN-based regression models to analyze bottle images and estimate fill levels, which may, for example, identify fill levels ranging from approximately 65% to 75% of total bottle capacity when water reaches the top edge of bottle wrappers, although other fill level ranges may be suitable depending on the specific bottle type and training requirements. For example, a plastic water bottle filled to approximately 60-80% capacity with water may provide appropriate resistance for compression training while allowing the trainee 114 to observe the deformation and recovery of the training object during each compression cycle. The bottle detection system may process bottle images through preprocessing steps including standardization to uniform dimensions such as 224×224 pixels, enhancement and normalization of brightness and contrast, and data augmentation techniques to simulate real-world variability. In some embodiments, the partially filled bottle may be filled to at least 40%, at least 50%, at least 60%, at least 70%, and/or at least 80% capacity with water, fluid material, and/or sealant to provide sufficient resistance for effective CPR training while maintaining appropriate compressibility characteristics.

Embodiments of the system 100 may accommodate various categories of household and everyday items that function as effective non-mannequin training objects. Cushions and pillows may provide soft, compressible surfaces that allow trainees 114 to practice proper hand positioning and compression depth while being easily visible to the capturing device 102. Rolled towels and/or blankets may be configured into cylindrical shapes that approximate the dimensions of a human torso, providing a stable platform for compression practice. Foam blocks and/or exercise mats may offer consistent compression characteristics and may be particularly suitable for repeated training sessions due to their durability and shape retention properties. Various inflatable items may provide adjustable compression resistance through controlled air pressure, with beach balls, exercise balls, and/or inflatable pillows being partially inflated to create training objects with customizable firmness levels. These inflatable training objects may allow trainees 114 to experience different compression depths and may provide visual feedback through their deformation during compression exercises, with the capturing device 102 effectively recording the compression and release cycles to enable the computing module 104c to calculate compression depth and timing parameters.

Embodiments of the system 100 may work with training objects constructed from everyday materials that simulate the size and compressibility characteristics of a human chest. Cardboard boxes filled with packing materials, newspapers, and/or foam may create training platforms that provide appropriate resistance while being cost-effective and readily available. Fabric-based training objects, such as stuffed animals, throw pillows, and/or clothing bundles, may offer soft compression surfaces that allow for extended training sessions without causing discomfort to the trainee 114. These fabric-based objects may also provide visual contrast against various backgrounds, facilitating accurate pose estimation by the marking module 104b. Exercise-related items specifically designed for physical therapy may possess appropriate compression characteristics for CPR training, with resistance bands, exercise balls, foam rollers, yoga blocks, and/or meditation cushions serving as training platforms while providing varying levels of compression resistance and stable, compressible surfaces that maintain their shape throughout multiple compression cycles.

The non-mannequin training objects may be characterized by specific dimensional and material properties that enhance their effectiveness for CPR training assessment. Objects with dimensions approximating those of an adult human torso, typically ranging from about 12 to 18 inches in width and 8 to 12 inches in height, may provide realistic training scenarios while remaining easily portable. For example, non-mannequin training objects may include objects with dimensions of approximately 12 inches in width and 8 inches in height, 14 inches in width and 10 inches in height, 16 inches in width and 11 inches in height, and/or 18 inches in width and 12 inches in height. In some embodiments, the non-mannequin training objects may have width-to-height ratios ranging from approximately 1.5:1 to 1.8:1 to simulate the proportions of an adult human chest. The dimensions may be adjusted based on whether the training is focused on adult, pediatric, and/or infant CPR techniques, with smaller dimensions being appropriate for pediatric and/or infant CPR training scenarios. The training objects may exhibit compressibility characteristics that allow for compression depths of approximately 1.5 to 2.5 inches, 1.8 to 2.4 inches, 2.0 to 2.4 inches, and/or 2.0 to 2.2 inches, which corresponds to the recommended compression depth for adult CPR according to established guidelines. In some embodiments, the non-mannequin training objects may be configured to provide tactile feedback when compression depths reach specific thresholds, such as 1.5 inches, 1.8 inches, 2.0 inches, 2.2 inches, and/or 2.4 inches, allowing trainees to develop muscle memory for proper compression technique. The compressibility characteristics may be adjusted by modifying the fill level, material composition, and/or structural design of the training objects to accommodate different training scenarios, including pediatric CPR training which may require shallower compression depths of approximately 1.0 to 2.0 inches, 1.2 to 1.8 inches, and/or 1.5 to 1.7 inches.

Various embodiments of the system 100 may utilize training objects with different surface textures and visual characteristics that facilitate accurate video analysis and provide enhanced feedback capabilities. Objects with uniform colors and/or patterns may provide clear visual references for the marking module 104b to track hand positioning and movement patterns, while training objects with contrasting colors and/or markings may help define target compression zones, enabling the computing module 104c to assess hand placement accuracy relative to the intended compression area. Some training objects may include visual indicators and/or measurement scales that provide additional reference points for compression depth assessment. Training objects may accommodate auditory and/or tactile feedback during compression exercises, with objects containing materials that produce sounds when compressed, such as partially filled containers with loose materials, providing additional sensory feedback to complement the visual analysis performed by the system 100. Training objects with varying surface textures may help trainees 114 develop proper hand positioning techniques while providing distinct visual features that enhance pose estimation accuracy.

The non-mannequin training objects may be selected based on their availability in different geographic regions and cultural contexts, ensuring broad accessibility of the training system 100. Objects commonly found in households worldwide may serve as universal training platforms that eliminate barriers to CPR training access, with regional variations in available materials being accommodated by the system 100 through its adaptable video analysis capabilities, allowing the preprocessing module 104a to standardize video inputs regardless of the specific training object characteristics. Some embodiments of the system 100 may utilize training objects that can be easily modified and/or adjusted to provide different training scenarios, with adjustable training objects including containers with removable contents, inflatable items with variable pressure settings, and/or modular objects that can be reconfigured for different training exercises. These adaptable training objects may enable progressive training programs where compression resistance and/or object dimensions are modified as the trainee 114 develops proficiency in CPR techniques.

Embodiments of the preprocessing module 104a may be configured to process the at least one video captured during the CPR training session to generate a standardized video that facilitates consistent and accurate analysis by subsequent modules of the system 100. The preprocessing module 104a may receive video input from the capturing device 102 through the wireless communication network 108 and apply various processing techniques to normalize video characteristics, enhance visual quality, and prepare the video data for analysis by the marking module 104b. The preprocessing module 104a may implement multiple processing stages that operate sequentially or in parallel to transform raw video input into a standardized format suitable for pose estimation and movement analysis.

The preprocessing module 104a may implement frame rate standardization techniques to ensure consistent temporal resolution across different video inputs captured by various types of capturing devices 102. Videos captured at different frame rates, such as 24, 30, 60, or 120 frames per second, may be converted to a standardized frame rate that optimizes the balance between computational efficiency and analytical accuracy. The preprocessing module 104a may employ frame interpolation algorithms to increase frame rates for videos captured at lower rates, or frame decimation techniques to reduce frame rates for high-speed recordings. The standardized frame rate may be selected based on the specific requirements of the pose estimation algorithms implemented by the marking module 104b, with typical standardized rates ranging from 15 to 60 frames per second, 20 to 50 frames per second, or 25 to 40 frames per second.

The preprocessing module 104a may implement frame extraction capabilities that systematically read video files and convert them into sequences of individual frames for subsequent analysis. The preprocessing module 104a may utilize video decoding algorithms that parse various video file formats, such as MP4, AVI, MOV, or other standard formats, and extract individual frames at specified intervals or frame rates. The frame extraction process may involve reading video metadata to determine the original frame rate, resolution, and encoding parameters, enabling optimization of the extraction process for each specific video input. The preprocessing module 104a may implement selective frame extraction that captures frames at predetermined intervals, such as every frame, every second frame, or at specific time intervals, depending on the analytical requirements and computational constraints of the system 100. The frame extraction process may include timestamp preservation that maintains temporal relationships between extracted frames, ensuring accurate synchronization with subsequent pose estimation and movement analysis.

The preprocessing module 104a may apply resolution normalization techniques to standardize video dimensions and pixel density across different capturing devices 102. Videos captured at various resolutions, such as 720p, 1080p, 4K, or custom resolutions, may be scaled to a standardized resolution that balances computational requirements with analytical precision. The preprocessing module 104a may implement upscaling algorithms for lower-resolution videos or downscaling techniques for high-resolution inputs, ensuring that all processed videos maintain consistent pixel dimensions and aspect ratios. The standardized resolution may be set to 1920×1080 pixels, 1280×720 pixels, 960×540 pixels, or 640×480 pixels, depending on the computational capabilities of the central server 104 and the accuracy requirements of the pose estimation process.

The preprocessing module 104a may incorporate multi-view input handling capabilities that coordinate the processing of video inputs captured from different viewing angles, such as front view and side view perspectives of the CPR training session. The preprocessing module 104a may implement view-specific processing pipelines that apply different preprocessing parameters and techniques based on the camera angle and perspective of each video input. For front view videos, the preprocessing module 104a may emphasize hand positioning analysis and symmetry detection algorithms, while for side view videos, the preprocessing module 104a may focus on compression depth measurement and body posture assessment. The preprocessing module 104a may implement temporal synchronization mechanisms that align multiple video streams captured simultaneously from different angles, ensuring that corresponding frames from front and side views represent the same temporal moment in the CPR training session. The preprocessing module 104a may utilize cross-view calibration techniques that establish spatial relationships between different camera perspectives, enabling accurate coordinate transformation and measurement consistency across multiple viewing angles. The preprocessing module 104a may generate synchronized multi-view frame sequences that maintain temporal alignment and spatial correspondence between different camera perspectives throughout the preprocessing pipeline.

The preprocessing module 104a may incorporate background subtraction and isolation techniques to enhance the visibility of the trainee 114 and the non-mannequin training object within the video frame. The preprocessing module 104a may implement adaptive background modeling algorithms that learn the static elements of the training environment and subtract them from each video frame, leaving only the moving elements such as the trainee 114 and any dynamic changes in the training object. These background subtraction techniques may include Gaussian mixture models, median filtering approaches, or machine learning-based background estimation methods. The preprocessing module 104a may apply morphological operations, such as erosion and dilation, to refine the foreground mask and eliminate noise artifacts that could interfere with subsequent pose estimation by the marking module 104b.

The preprocessing module 104a may implement color space conversion and normalization techniques to standardize the color representation of video frames regardless of the capturing device 102 characteristics or lighting conditions. Videos captured in different color spaces, such as RGB, YUV, HSV, or device-specific color profiles, may be converted to a standardized color space that optimizes the performance of pose estimation algorithms. The preprocessing module 104a may apply color correction algorithms to compensate for variations in white balance, exposure, or color temperature that may occur due to different lighting conditions or camera settings. The preprocessing module 104a may convert all video inputs to the sRGB color space with standardized gamma correction, or may apply histogram equalization techniques to normalize brightness and contrast levels across different video sources.

The preprocessing module 104a may perform step 302 of the method 300 by implementing noise reduction and image enhancement techniques that improve the visual quality of the video while preserving important details needed for accurate pose estimation. The preprocessing module 104a may apply temporal filtering algorithms that analyze multiple consecutive frames to identify and reduce random noise while maintaining the integrity of motion information. Spatial filtering techniques, such as Gaussian blur, median filtering, or bilateral filtering, may be employed to smooth image textures while preserving edge information that may be important for detecting body landmarks. The preprocessing module 104a may implement adaptive filtering algorithms that adjust the level of noise reduction based on the detected noise characteristics of each video segment.

The preprocessing module 104a may implement conditional processing selection mechanisms that automatically determine which preprocessing techniques to apply based on the characteristics and quality of each video input. The preprocessing module 104a may analyze video properties such as noise levels, lighting conditions, motion blur, and compression artifacts to select appropriate processing algorithms and parameter settings. For videos with high noise levels, the preprocessing module 104a may enable advanced denoising algorithms, while for videos with adequate quality, the preprocessing module 104a may apply minimal processing to preserve computational efficiency. The preprocessing module 104a may implement quality assessment algorithms that evaluate factors such as signal-to-noise ratio, contrast levels, sharpness metrics, and motion blur indicators to determine the optimal preprocessing configuration for each video input. The preprocessing module 104a may utilize machine learning-based quality assessment that automatically classifies video inputs and selects appropriate preprocessing pipelines based on learned patterns from historical video data. The preprocessing module 104a may provide configurable processing options that allow users or system administrators to manually enable or disable specific preprocessing techniques based on training requirements, computational resources, or quality preferences.

The preprocessing module 104a may incorporate motion stabilization techniques to compensate for camera movement or vibrations that may occur during video capture by the capturing device 102. The preprocessing module 104a may implement digital image stabilization algorithms that analyze frame-to-frame motion vectors and apply compensatory transformations to reduce unwanted camera movement while preserving the natural motion of the trainee 114 during CPR exercises. These stabilization techniques may include feature-based tracking methods that identify stable reference points in the video frame, or optical flow algorithms that estimate global motion patterns. The preprocessing module 104a may apply geometric transformations, such as translation, rotation, or scaling, to align consecutive frames and create a more stable video sequence that facilitates accurate pose estimation by the marking module 104b.

The preprocessing module 104a may implement temporal segmentation techniques to identify and isolate specific portions of the video that contain relevant CPR training activities. The preprocessing module 104a may analyze motion patterns, audio cues, or visual changes to automatically detect the beginning and end of CPR compression sequences, eliminating irrelevant video segments such as setup periods, breaks, or post-training discussions. The preprocessing module 104a may implement activity recognition algorithms that can distinguish between different types of movements, such as hand positioning, compression cycles, or rest periods, allowing for more targeted analysis by subsequent modules. The temporal segmentation may result in multiple video segments that are processed independently or combined into a continuous standardized video with enhanced focus on relevant training activities.

The preprocessing module 104a may apply geometric correction techniques to compensate for lens distortion, perspective effects, or viewing angle variations that may affect the accuracy of pose estimation and movement analysis. The preprocessing module 104a may implement camera calibration algorithms that correct for barrel distortion, pincushion distortion, or other optical aberrations introduced by the capturing device 102. Perspective correction techniques may be applied to normalize the viewing angle and ensure that measurements of compression depth and hand positioning remain accurate regardless of the camera placement relative to the training area. The preprocessing module 104a may use reference objects or calibration patterns within the video frame to establish spatial relationships and apply appropriate geometric transformations to create a standardized perspective view.

The preprocessing module 104a may incorporate adaptive processing techniques that adjust the preprocessing parameters based on the characteristics of each individual video input. The preprocessing module 104a may analyze video metadata, such as capture device specifications, recording settings, or environmental conditions, to select appropriate processing algorithms and parameter values. For example, videos captured in low-light conditions may receive different noise reduction and contrast enhancement treatments compared to videos captured in well-lit environments. The preprocessing module 104a may implement machine learning algorithms that learn optimal preprocessing parameters from historical video data and training outcomes, continuously improving the standardization process based on feedback from the overall system 100 performance.

The preprocessing module 104a may implement compression and encoding optimization techniques to balance video quality with computational efficiency and storage requirements. The preprocessing module 104a may apply lossless or near-lossless compression algorithms that reduce file sizes while preserving the visual information needed for accurate pose estimation. The preprocessing module 104a may implement region-of-interest encoding that applies higher quality settings to areas of the video containing the trainee 114 and training object while using more aggressive compression for background areas. The standardized video output may be encoded in formats optimized for subsequent processing by the marking module 104b, such as uncompressed formats for maximum quality or efficiently compressed formats that maintain analytical accuracy while reducing computational overhead.

The classification module 104d may implement comprehensive compression quality assessment algorithms that evaluate multiple aspects of CPR technique for each detected compression cycle. The classification module 104d may classify compressions as full or incomplete based on depth measurements relative to established CPR guidelines, identifying compressions that achieve adequate depth ranges of approximately 2.0 to 2.4 inches for adult CPR, 1.5 to 2.0 inches for pediatric CPR, and/or 1.0 to 1.5 inches for infant CPR. The classification module 104d may detect incomplete compressions by identifying depth measurements that fall below the minimum threshold requirements, flagging these events for corrective feedback and technique improvement guidance. The classification module 104d may implement left-right imbalance detection algorithms that analyze the symmetry of hand positioning and force application during compression cycles. The classification module 104d may compare the vertical displacement patterns of left and right hand positions to identify asymmetric compression techniques where one hand applies significantly more force than the other, potentially reducing compression effectiveness and increasing the risk of rib fractures. The classification module 104d may calculate imbalance metrics by measuring the difference in compression depth between left and right hand positions, applying threshold criteria such as 0.2 inches, 0.3 inches, 0.4 inches, and/or 0.5 inches to classify compressions as balanced or imbalanced. The classification module 104d may implement symmetry checking algorithms that evaluate the horizontal alignment and coordinated movement of both hands throughout the compression cycle. The classification module 104d may analyze the lateral displacement of hand positions relative to the centerline of the training object, identifying hand drift, asymmetric placement, and/or uncoordinated movement patterns that may compromise compression quality. The classification module 104d may utilize geometric analysis techniques to assess hand positioning symmetry, calculating metrics such as hand separation distance, angular alignment, and/or center-of-pressure distribution to determine whether the trainee 114 maintains proper bilateral hand coordination during CPR compressions.

Referring to FIG. 1 and FIG. 3, embodiments of the marking module 104b may be configured to use pose estimation techniques to identify and mark one or more specific points corresponding to body movements of the trainee 114 during the CPR training session based on the standardized video received from the preprocessing module 104a. The marking module 104b may perform step 304 of the method 300 by implementing machine learning-based pose estimation models, computer vision algorithms, and/or statistical analysis methods to create a mapping of anatomical reference points that facilitate accurate analysis of CPR technique and performance.

The marking module 104b may implement an encoder-decoder architecture with skip connections for keypoint detection and pose estimation. This architecture incorporates a heatmap-based convolutional neural network (CNN) for keypoint localization and a regression CNN component that predicts the (x, y, visibility) coordinates of a plurality of keypoints corresponding to key anatomical landmarks relevant to CPR performance assessment. In some embodiments, the system may utilize 33 keypoints, though other embodiments may employ different numbers of keypoints, such as 17, 25, or other suitable quantities of anatomical landmarks depending on the specific pose estimation model and analysis requirements. The overall architecture may be inspired by the Stacked Hourglass Network design, which enables multi-scale feature processing and iterative refinement of keypoint predictions through repeated bottom-up and top-down processing pathways.

The encoder-decoder architecture may process input images with dimensions of approximately 256×256×3 pixels, representing RGB color images captured by the capturing device 102. The encoder portion comprises a series of convolutional layers that progressively downsample the input image to extract hierarchical feature representations at multiple scales, transforming the input from 256×256×3 dimensions through 128×128×16, 64×64×32, 32×32×32, 16×16×32, and finally to 8×8×32 dimensions. The decoder portion implements upsampling operations with skip connections that combine low-level spatial details from the encoder with high-level semantic information to generate precise keypoint localizations, progressively upsampling from 8×8×32 back through 16×16×32, 32×32×32, to 64×64×32 dimensions while preserving spatial accuracy through skip connections. The final output layer generates feature maps with dimensions of approximately 64×64×99, representing heatmaps and offset predictions for keypoint detection. The 99-channel output comprises one heatmap channel and two offset map channels for each of a plurality of keypoints, such as 33 keypoints in some embodiments, enabling precise localization of anatomical landmarks such as shoulder joints, elbow joints, wrist joints, hand positions, hip joints, and other body landmarks essential for CPR technique evaluation. Other embodiments may utilize different numbers of keypoints, such as 17, 25, or other suitable numbers of anatomical landmarks depending on the specific pose estimation model and analysis requirements.

The marking module 104b may utilize established pose estimation models such as OpenPose, MediaPipe, PoseNet, and/or custom-trained models specifically optimized for CPR training scenarios. These models analyze each frame of the standardized video to identify and mark key anatomical points including shoulder joints, elbow joints, wrist joints, hand positions, hip joints, knee joints, ankle joints, and torso landmarks. The marking module 104b may track these anatomical points across multiple video frames to create temporal sequences that represent the movement patterns of the trainee 114 during CPR compressions, and may implement ensemble methods that combine multiple pose estimation algorithms to improve accuracy and robustness under varying lighting conditions, camera angles, and/or body positions.

The marking module 104b may focus on identifying specific anatomical landmarks particularly relevant to CPR performance assessment, including upper body landmarks such as both shoulders, both elbows, both wrists, and individual finger joints to track hand placement and arm positioning during compression cycles. The marking module 104b may identify torso landmarks such as the center of the chest, sternum position, and/or ribcage boundaries to establish reference points for measuring compression depth and hand placement accuracy. In some embodiments, the marking module 104b may track head and neck positions to assess overall body alignment and posture, as well as lower body landmarks including hip positions, knee joints, and/or foot placement to evaluate the trainee's 114 stability and body mechanics during compression activities.

Embodiments of the marking module 104b may implement temporal tracking algorithms that follow the movement of marked anatomical points across consecutive video frames to create continuous motion trajectories. The marking module 104b may utilize optical flow algorithms, Kalman filtering techniques, and/or particle filtering methods to maintain consistent tracking of body landmarks even when temporary occlusions or motion blur occur. The marking module 104b may implement predictive tracking algorithms that estimate the likely position of anatomical landmarks in subsequent frames based on previous movement patterns, and may apply smoothing algorithms to reduce noise and jitter while preserving natural movement characteristics needed for accurate CPR analysis. The marking module 104b may generate frame-by-frame landmark sets as timestamped output data, where each frame contains the complete set of anatomical landmark coordinates with corresponding temporal information that enables precise synchronization with subsequent analysis modules.

As shown in FIG. 3, the marking module 104b may perform step 304 by implementing specialized detection algorithms for identifying compression-specific movements and phases within the CPR training session. The marking module 104b may analyze the vertical displacement patterns of hand positions relative to the training dummy 112 to identify individual compression cycles, including the downward compression phase, the hold phase at maximum compression depth, and the upward release phase. The marking module 104b may detect compression events by identifying characteristic motion patterns such as rapid downward movement of the hands followed by controlled upward movement, and may mark specific time points within each compression cycle, such as compression initiation, maximum compression depth, and/or complete release, to enable detailed timing analysis by subsequent modules of the system 100.

The marking module 104b may incorporate reference point detection techniques to establish spatial relationships between the trainee 114 and the training dummy 112 or other non-mannequin training objects. The marking module 104b may identify and mark key features of the training object, such as the compression target area, object boundaries, and/or visual markers that have been placed on the training object to facilitate analysis. In some embodiments, the marking module 104b may detect the relative position and orientation of the training object within the video frame to establish a coordinate system for measuring compression depth, hand placement accuracy, and/or body positioning relative to the training target. The marking module 104b may track changes in the training object's appearance during compression cycles, such as deformation of a partially filled bottle or displacement of cushioning materials, to provide additional reference points for compression depth estimation.

The marking module 104b may implement adaptive marking techniques that adjust the pose estimation parameters based on the characteristics of each individual trainee 114 or training scenario. The marking module 104b may analyze body proportions, clothing characteristics, and/or environmental factors to optimize the pose estimation algorithms for each specific video input, such as adjusting detection thresholds for trainees 114 wearing loose-fitting clothing or modifying tracking parameters for challenging lighting conditions. The marking module 104b may implement personalization algorithms that learn the typical movement patterns and anatomical characteristics of individual trainees 114 over multiple training sessions, improving the accuracy and consistency of landmark detection for repeat users of the system 100.

Embodiments of the marking module 104b may incorporate multi-scale analysis techniques that examine body movements at different temporal and spatial resolutions to capture both fine-grained details and overall movement patterns. The marking module 104b may analyze hand and finger movements at high temporal resolution to detect subtle variations in hand positioning and grip characteristics during CPR compressions, while simultaneously analyzing overall body posture and alignment at lower temporal resolution to assess broader aspects of CPR technique. The marking module 104b may combine these multi-scale analyses to create a comprehensive representation of the trainee's 114 CPR performance that captures both detailed technical aspects and overall technique quality.

The marking module 104b may implement confidence scoring and quality assessment techniques to evaluate the reliability of detected anatomical landmarks and movement patterns. The marking module 104b may assign confidence scores to each marked point based on factors such as visual clarity, consistency with anatomical constraints, and/or agreement with temporal movement patterns. In some cases, the marking module 104b may identify video segments or anatomical landmarks with low confidence scores and apply specialized processing techniques, such as enhanced filtering, alternative detection algorithms, and/or temporal interpolation, to improve marking accuracy. The marking module 104b may flag uncertain or potentially inaccurate markings for review by subsequent modules or may exclude low-confidence data from further analysis to maintain the overall accuracy of the CPR assessment process.

The marking module 104b may incorporate real-time processing capabilities that enable immediate marking and analysis of body movements during live CPR training sessions. The marking module 104b may implement optimized algorithms and parallel processing techniques to minimize the computational delay between video capture by the capturing device 102 and the generation of marked anatomical landmarks. In some embodiments, the marking module 104b may utilize hardware acceleration techniques, such as GPU processing, specialized neural network processors, and/or distributed computing resources, to achieve real-time performance while maintaining high accuracy in pose estimation and landmark detection.

Embodiments of the marking module 104b may implement specialized algorithms for handling challenging visual conditions that may occur during CPR training sessions. The marking module 104b may include techniques for managing partial occlusions when the trainee's 114 body position obscures certain anatomical landmarks, such as when arms cross over the torso during compression movements. The marking module 104b may implement shadow detection and compensation algorithms to maintain accurate landmark detection when lighting conditions create shadows that interfere with pose estimation. In some cases, the marking module 104b may utilize temporal information from previous frames to estimate the positions of temporarily occluded landmarks, maintaining continuous tracking throughout the CPR training session even when visual conditions are suboptimal.

Embodiments of the marking module 104b may incorporate alternative pose estimation approaches that provide enhanced detail and accuracy for specific aspects of CPR performance analysis. The marking module 104b may implement face detection models that capture detailed facial landmarks and head orientation information, enabling more precise assessment of the trainee's 114 attention and body alignment during CPR exercises. The marking module 104b may utilize hand-specific pose estimation models that provide detailed finger joint tracking and hand gesture recognition capabilities, allowing for more accurate analysis of hand positioning, grip characteristics, and finger placement during compression cycles. These hand-specific models may capture fine-grained details such as finger interlacing patterns, wrist angle variations, and palm contact area measurements that may not be available through general-purpose pose estimation approaches.

The marking module 104b may implement three-dimensional landmark estimation capabilities that extend beyond traditional two-dimensional pose analysis to provide depth information and spatial relationships between anatomical landmarks. The marking module 104b may utilize stereo vision techniques, depth cameras, and/or monocular depth estimation algorithms to generate three-dimensional coordinate data for each anatomical landmark, enabling more accurate measurement of compression depth, body positioning, and spatial relationships during CPR exercises. The marking module 104b may utilize 3D landmark data to calculate volumetric measurements, spatial angles, and three-dimensional trajectories that provide enhanced insight into the biomechanical aspects of CPR performance. In some cases, the marking module 104b may combine 2D and 3D landmark estimation techniques to provide comprehensive spatial analysis while maintaining computational efficiency and compatibility with various capturing device 102 configurations.

The marking module 104b may incorporate anatomical constraint validation techniques that ensure the marked body landmarks conform to realistic human anatomy and movement patterns. The marking module 104b may implement biomechanical models that define acceptable ranges of joint angles, limb lengths, and/or movement velocities to validate the accuracy of detected landmarks. In some embodiments, the marking module 104b may apply kinematic constraints that ensure marked joint positions maintain realistic relationships with adjacent body segments, rejecting or correcting landmark detections that violate anatomical principles. The marking module 104b may utilize these constraint validation techniques to improve the overall reliability of pose estimation and reduce errors that could propagate to subsequent analysis modules of the system 100.

Referring to FIG. 1 and FIG. 3, embodiments of the computing module 104c may be configured to compute body movement parameters for CPR based on the marked points received from the marking module 104b, performing step 306 of the method 300. The computing module 104c may analyze the spatial and temporal characteristics of the marked anatomical landmarks to derive quantitative measurements that characterize the trainee's 114 CPR performance, achieving compression depth estimation accuracy within ±2 mm when validated against known object deformation characteristics in some embodiments. In some embodiments, the computing module 104c may implement mathematical algorithms, statistical analysis techniques, and/or biomechanical modeling approaches to transform the raw landmark position data into meaningful performance metrics that can be evaluated against established CPR guidelines. The computing module 104c may process multiple types of body movement parameters simultaneously, including compression depth measurements, compression rate calculations, hand positioning accuracy assessments, and/or body posture evaluations.

With continued reference to FIG. 1, the computing module 104c may be configured to calculate compression depth parameters by analyzing the vertical displacement of hand positions relative to the training dummy 112 or other non-mannequin training objects. The computing module 104c may establish a baseline reference position for the hands when they are positioned on the compression target area and measure the maximum downward displacement during each compression cycle. The computing module 104c may implement anthropometric calibration techniques that utilize the trainee's 114 height and established body segment ratios to transform pixel-based measurements into calibrated real-world distances. For example, the computing module 104c may receive user height information and apply established anthropometric relationships, such as the ratio of torso length to total height ranging from, for example, approximately 0.25 to 0.35, elbow-to-wrist length to total height ranging from, for example, approximately 0.146 to 0.165, and/or shoulder-to-elbow length to total height ranging from, for example, approximately 0.186 to 0.207, to establish pixel-to-centimeter conversion factors for accurate depth measurements. The computing module 104c may implement height-based image segmentation techniques that calculate the total pixel height of the trainee 114 by measuring vertical distances between key anatomical landmarks including head, shoulders, hips, knees, and feet, then derive a pixel-to-centimeter ratio by dividing the user's actual height by their measured pixel height. The computing module 104c may measure the pixel distance between torso landmarks and compare this measurement to the expected torso length based on the trainee 114's height, calculating a pixel-to-distance (e.g., centimeter) ratio. In some cases, the computing module 104c may utilize coordinate transformation techniques to account for camera angle variations and ensure accurate depth measurements regardless of the capturing device 102 positioning. The computing module 104c may implement filtering algorithms to smooth the displacement measurements and reduce noise artifacts that could affect the accuracy of compression depth calculations.

For example, the computing module 104c may implement a sign-flip half-cycle counting approach that uses the shoulders as a stable reference line for compression depth calculation. In some embodiments implementing this approach, the computing module 104c may record the vertical position of both shoulders when the trainee 114 begins the CPR exercise, establishing shoulder reference coordinates such as y_ref_left_shoulder and y_ref_right_shoulder. The computing module 104c may apply anthropometric calibration by measuring the pixel distance between anatomical landmarks and correlating these measurements with known body segment proportions to establish real-world scaling factors. For example, the computing module 104c may measure the pixel distance between torso landmarks and compare this measurement to the expected torso length based on the trainee's 114 height, calculating a pixel-to-centimeter ratio that may range from approximately 0.5 to 3.0 pixels per centimeter, 0.8 to 2.5 pixels per centimeter, 1.0 to 2.0 pixels per centimeter, and/or 1.2 to 1.8 pixels per centimeter, depending on camera distance and resolution settings. During the CPR training session, the computing module 104c may track the vertical positions of both wrists for each video frame and compare the wrist positions to the established shoulder reference line. The computing module 104c may determine that both wrists have moved significantly below the shoulder line when the vertical coordinates indicate a downward compression phase, and may detect when both wrists move back above the shoulder line during the upward release phase. The computing module 104c may implement state-based counting logic that tracks compression cycles by monitoring these upward and downward transitions, incrementing compression counts by half-cycle increments to achieve full compression cycle counting.

In some embodiments, the computing module 104c may implement a harmonious movement analysis approach that evaluates the coordinated movement between shoulders, elbows, and wrists during CPR compressions. The computing module 104c may establish baseline shoulder positions by recording initial coordinates such as y_initial_left_shoulder and y_initial_right_shoulder at the beginning of the CPR exercise. The computing module 104c may implement anthropometric-based calibration processes that utilize body segment length ratios to convert pixel measurements into real-world distances, enabling accurate assessment regardless of camera positioning and/or trainee 114 physical characteristics. For example, the computing module 104c may calculate the upper arm length in pixels by measuring the distance between shoulder and elbow landmarks, then apply the anthropometric ratio of upper arm length to total height (approximately 0.186 to 0.207) to establish calibration factors for depth measurements. The computing module 104c may analyze the vertical displacement of shoulders, elbows, and wrists as a unified system, where proper technique may be characterized by the shoulder, elbow, and wrist forming a straight line that moves up and down together during compression cycles.

The computing module 104c may implement shoulder-driven compression detection algorithms that identify proper technique when shoulder displacement closely matches wrist displacement, indicating that the compressions are powered by shoulder movement rather than elbow bending. The computing module 104c may calculate displacement ratios between shoulder and wrist movements, with ratios approaching 1.0 (such as 0.85 to 1.15, 0.90 to 1.10, or 0.95 to 1.05) indicating proper elbow lock maintenance throughout the compression cycle. This harmonious movement principle may enable indirect assessment of elbow lock compliance, as proper straight-arm positioning may result in the shoulder and wrist descending and ascending by approximately equal vertical distances during each compression cycle. The computing module 104c may detect elbow bending deviations by identifying cases where the vertical displacement of the shoulder differs significantly from the vertical displacement of the wrist, such as when the wrist moves downward more than the shoulder during compression phases, indicating that the elbow has bent and compromised the rigid arm positioning required for effective CPR. The computing module 104c may apply unified movement validation that confirms the shoulder, elbow, and wrist maintain consistent spatial relationships during both downward compression and upward release phases, ensuring that the entire arm operates as a single rigid unit throughout the CPR exercises.

In some embodiments, the computing module 104c may implement a smoothed depth signal with peak and trough detection approach that treats compression as a waveform by tracking the vertical distance between the wrists and a reference point over time. The computing module 104c may establish a shoulder reference by computing the midpoint between the left and right shoulders for each video frame, calculating y_torso_mid as the average of y_left_shoulder and y_right_shoulder coordinates. The computing module 104c may calculate wrist depth relative to the shoulder reference by determining the average wrist vertical position and measuring the distance from the torso reference point, generating a continuous depth signal over time that may be calibrated to real-world measurements using anthropometric scaling factors. The computing module 104c may apply advanced filtering algorithms including moving average filters with configurable window sizes, such as 3 frames, 5 frames, 7 frames, or 10 frames, Kalman filtering techniques that model compression motion dynamics, Savitzky-Golay filters that preserve signal characteristics while reducing noise, and/or adaptive filtering methods that adjust smoothing parameters based on signal quality and movement patterns. The computing module 104c may implement peak and trough detection algorithms that identify local maxima and minima in the smoothed depth signal, where troughs correspond to the deepest hand positions during compression cycles and peaks correspond to the highest positions during release phases. The computing module 104c may count compression cycles by detecting transitions from peaks to troughs and back, applying minimum depth thresholds that may be calibrated to real-world measurements, such as 1.0 to 3.0 inches, 1.5 to 2.5 inches, 1.8 to 2.4 inches, and/or 2.0 to 2.2 inches, to ensure only meaningful compressions are recognized.

In some cases, the computing module 104c may implement side view analysis that focuses on measuring true vertical hand movement and compression depth, providing robust detection that may be resistant to noise and body shifting while allowing enforcement of minimum depth requirements. The computing module 104c may implement front view analysis that tracks wrist positions relative to shoulders during compression cycles, monitoring when both wrists descend below their respective shoulder reference points during the compression phase and return above the shoulder reference points during the release phase to identify complete compression cycles. The computing module 104c may implement symmetry detection algorithms that monitor horizontal alignment of the hands by comparing x-coordinates of the left and right wrists, applying symmetry thresholds such as 10 pixels, 15 pixels, 20 pixels, or 25 pixels to detect proper hand positioning and identify potential hand drift or asymmetric placement. The computing module 104c may combine side view and front view analysis approaches to provide cross-validation of compression detection, where compressions may be counted as valid only when they meet depth criteria from side view analysis and symmetry criteria from front view analysis. For example, the computing module 104c may calculate compression depths ranging from approximately 1.0 to 3.0 inches, 1.5 to 2.5 inches, 1.8 to 2.4 inches, and/or 2.0 to 2.2 inches, depending on the specific CPR guidelines being evaluated and the age group of the simulated patient.

Embodiments of the computing module 104c may implement compression rate analysis algorithms that determine the frequency of compression cycles performed by the trainee 114 during the CPR training session. The computing module 104c may analyze the temporal patterns of hand movement to identify individual compression events and calculate the number of compressions performed per minute. The computing module 104c may utilize peak detection algorithms to identify the characteristic motion patterns associated with compression initiation and completion, enabling accurate counting of compression cycles even when the hand movements exhibit variations in amplitude or timing. In some embodiments, the computing module 104c may implement sliding window analysis techniques that calculate compression rates over different time intervals, such as 10-second windows, 30-second windows, and/or 60-second windows, to assess the consistency of compression timing throughout the training session. The computing module 104c may calculate compression rates ranging from approximately 80 to 120 compressions per minute, 90 to 110 compressions per minute, 95 to 105 compressions per minute, and/or 100 to 105 compressions per minute, depending on the specific CPR protocol being followed.

As shown in FIG. 3, the computing module 104c may perform step 306 by implementing hand positioning accuracy calculations that evaluate the lateral placement of the trainee's 114 hands relative to the optimal compression zone on the training object. The computing module 104c may define target compression areas based on anatomical landmarks or visual markers on the training dummy 112 and measure the deviation of actual hand positions from these target zones. The computing module 104c may calculate positioning errors in both horizontal and vertical directions, providing comprehensive feedback on hand placement accuracy. In some cases, the computing module 104c may implement geometric analysis algorithms that account for the three-dimensional positioning of the hands relative to the training object, considering factors such as hand orientation, finger positioning, and/or palm contact area. The computing module 104c may quantify hand positioning accuracy using metrics such as distance from the target center, percentage of hand area within the target zone, and/or angular deviation from the optimal hand orientation.

The computing module 104c may incorporate elbow angle measurement algorithms that assess the positioning of the trainee's 114 arms during compression cycles. The computing module 104c may calculate the angles between the upper arm, forearm, and hand segments using the marked shoulder, elbow, and wrist landmarks provided by the marking module 104b. The computing module 104c may implement elbow lock angle computation that specifically evaluates whether the trainee 114 maintains straight arm positioning during compression phases, calculating the deviation from the optimal 180-degree elbow extension and identifying elbow flexion that may reduce compression effectiveness. In some embodiments, the computing module 104c may track elbow angle variations throughout the compression cycle to evaluate whether the trainee 114 maintains proper arm positioning during both the compression and release phases, detecting elbow lock compliance by monitoring angle stability within acceptable ranges of approximately 170 to 180 degrees, 175 to 180 degrees, 177 to 180 degrees, and/or 178 to 180 degrees. The computing module 104c may implement trigonometric calculations to determine elbow angles using vector analysis of the shoulder-elbow and elbow-wrist segments, applying smoothing algorithms such as moving averages, median filtering, and/or Kalman filtering to reduce measurement noise caused by minor landmark detection variations. For example, the computing module 104c may calculate elbow angles ranging from approximately 160 to 180 degrees, 165 to 180 degrees, 170 to 180 degrees, and/or 175 to 180 degrees, corresponding to the straight-arm positioning recommended in CPR guidelines, with elbow lock detection thresholds that identify significant deviations exceeding 5 degrees, 10 degrees, 15 degrees, and/or 20 degrees from the target straight-arm position.

Referring again to FIG. 1, the computing module 104c may implement body posture analysis algorithms that evaluate the overall alignment and positioning of the trainee 114 relative to the training dummy 112. The computing module 104c may analyze the spatial relationships between marked landmarks such as the head, shoulders, hips, and/or knees to assess whether the trainee 114 maintains proper body mechanics during CPR exercises. The computing module 104c may calculate metrics such as torso angle relative to the training surface, shoulder alignment over the compression target, and/or weight distribution between the knees and hands. In some cases, the computing module 104c may implement center-of-mass calculations that estimate the trainee's 114 balance and stability during compression activities. The computing module 104c may utilize vector analysis techniques to determine the direction and magnitude of force application based on body positioning and may compare these measurements against biomechanical models of optimal CPR technique.

Embodiments of the computing module 104c may incorporate compression release analysis algorithms that evaluate the completeness and timing of the upward movement phase between compression cycles. The computing module 104c may analyze the trajectory of hand positions during the release phase to determine whether the trainee 114 allows complete chest recoil between compressions. The computing module 104c may calculate release velocity, maximum release height, and/or dwell time at the fully released position to assess compliance with CPR guidelines that emphasize complete chest recoil. In some embodiments, the computing module 104c may implement comparative analysis techniques that evaluate the symmetry and consistency of release movements across multiple compression cycles. The computing module 104c may quantify release completeness using metrics such as percentage of full release achieved, release velocity profiles, and/or timing ratios between compression and release phases.

The computing module 104c may implement compression consistency analysis algorithms that evaluate the uniformity of compression parameters across multiple cycles within a training session. The computing module 104c may calculate statistical measures such as standard deviation, coefficient of variation, and/or range of values for compression depth, rate, and timing parameters. In some cases, the computing module 104c may implement trend analysis techniques that identify gradual changes in compression quality over time, such as fatigue-related decreases in compression depth or increases in compression rate variability. The computing module 104c may utilize moving average calculations, regression analysis, and/or spectral analysis methods to characterize the temporal evolution of compression parameters throughout the training session. The computing module 104c may generate consistency scores that quantify the stability of CPR technique and may identify specific time periods or compression cycles that deviate significantly from the overall performance pattern.

As further shown in FIG. 1, the computing module 104c may incorporate force estimation algorithms that approximate the compression force applied by the trainee 114 based on the observed deformation characteristics of the training dummy 112 or non-mannequin training objects. The computing module 104c may analyze changes in the training object's appearance during compression cycles, such as the deformation of a partially filled bottle or the displacement of cushioning materials, to estimate the applied force. The computing module 104c may implement computer vision techniques to measure the extent of object deformation and may correlate these measurements with known force-deformation relationships for the specific training object being used, applying anthropometric scaling factors to account for the trainee's 114 physical characteristics and their relationship to force application capability. The computing module 104c may utilize body mass estimation algorithms that correlate measured body segment dimensions with expected body weight ranges, enabling force estimation calibration based on the trainee's 114 physical capacity. In some embodiments, the computing module 104c may utilize machine learning models trained on force-deformation data to improve the accuracy of force estimation from visual observations alone, incorporating advanced filtering techniques such as Kalman filtering for dynamic force estimation, particle filtering for non-linear force-deformation relationships, and/or adaptive filtering methods that adjust estimation parameters based on training object characteristics and deformation patterns. The computing module 104c may calculate estimated compression forces ranging from approximately 80 to 140 pounds, 90 to 130 pounds, 100 to 120 pounds, and/or 110 to 125 pounds, depending on the training object characteristics and the specific force requirements for effective CPR, with force estimates calibrated using anthropometric data to account for individual trainee 114 physical capabilities and optimal force application techniques.

Embodiments of the computing module 104c may implement multi-parameter correlation analysis techniques that examine the relationships between different body movement parameters to identify patterns indicative of proper or improper CPR technique. The computing module 104c may analyze correlations between compression depth and elbow angle, compression rate and body posture, hand positioning accuracy and compression consistency, and/or other parameter combinations. The computing module 104c may utilize statistical correlation methods, principal component analysis, and/or machine learning clustering techniques to identify parameter combinations that are associated with high-quality CPR performance. In some cases, the computing module 104c may implement weighted scoring algorithms that combine multiple body movement parameters into composite performance metrics, with weighting factors determined based on the relative importance of each parameter for CPR effectiveness.

The computing module 104c may incorporate adaptive parameter calculation techniques that adjust the computation algorithms based on the characteristics of individual trainees 114 or specific training scenarios. The computing module 104c may analyze trainee 114 physical characteristics, such as height, arm length, shoulder width, and/or body proportions, to customize the parameter calculation methods for each individual using established anthropometric databases and body segment ratio tables. The computing module 104c may implement anthropometric profiling algorithms that automatically estimate body segment lengths and proportions from measured landmark distances, enabling personalized calibration without requiring manual input of physical measurements. For example, the computing module 104c may estimate total height from measured head-to-shoulder distance using the anthropometric ratio of head height to total height (approximately 0.130 to 0.145), or may estimate arm span from shoulder width measurements using typical arm span to height ratios (approximately 1.00 to 1.06). In some embodiments, the computing module 104c may implement personalization algorithms that learn the typical movement patterns and performance characteristics of individual trainees 114 over multiple training sessions, enabling more accurate and relevant parameter calculations through adaptive filtering techniques such as recursive least squares estimation, extended Kalman filtering for non-linear parameter adaptation, and/or machine learning-based parameter optimization. The computing module 104c may adjust calculation thresholds, filtering parameters, measurement scaling factors, and/or measurement techniques based on factors such as trainee experience level, training object type, environmental conditions during the CPR training session, and/or historical performance patterns that indicate individual biomechanical characteristics and movement preferences.

Referring to FIG. 3, the computing module 104c may perform step 306 by implementing real-time parameter calculation capabilities that enable immediate computation of body movement parameters during live CPR training sessions. The computing module 104c may utilize optimized algorithms and parallel processing techniques to minimize the computational delay between receiving marked landmarks from the marking module 104b and generating computed parameters for use by subsequent modules of the system 100. In some cases, the computing module 104c may implement streaming data processing approaches that calculate parameters incrementally as new landmark data becomes available, rather than waiting for complete compression cycles to be captured. The computing module 104c may provide immediate parameter updates to other modules of the system 100, enabling real-time feedback and assessment during CPR training exercises.

Referring to FIG. 1 and FIG. 3, embodiments of the classification module 104d may be configured to implement a machine learning model that classifies CPR compressions performed on the non-mannequin training object based on the computed body movement parameters received from the computing module 104c, performing step 308 of the method 300. The classification module 104d may analyze quantitative measurements and temporal patterns derived from the trainee's 114 body movements to generate compression classifications that indicate whether individual compression cycles conform to established CPR guidelines, achieving greater than 95% accuracy in compression detection with false positive rates maintained below 3% in some embodiments. The classification module 104d may process smoothed measurement signals including compression depth data, hand position coordinates, body posture metrics, and temporal movement patterns to perform comprehensive assessment of CPR technique quality.

The classification module 104d may utilize various machine learning architectures, including supervised learning models, deep neural networks, ensemble methods, and/or hybrid approaches that combine multiple classification techniques to achieve robust and accurate assessment of CPR performance. The classification module 104d may implement a machine learning architecture that builds upon the pose estimation capabilities of the marking module 104b, incorporating heatmap-based CNN outputs and (x, y, visibility) coordinate predictions of the 33 keypoints as input features. The machine learning model may utilize a Stacked Hourglass Network-inspired architecture to process temporal sequences of keypoint data, enabling the classification module 104d to capture both spatial relationships between anatomical landmarks and temporal patterns across compression cycles that may be indicative of proper CPR technique. This architecture may process multi-scale temporal features, analyzing both fine-grained movement details within individual compression cycles and broader patterns across multiple compression sequences.

The machine learning model may be specifically trained to extract CPR-specific features from the body movement parameters computed by the computing module 104c. Input features may include compression depth measurements, compression rate calculations, hand positioning coordinates, elbow angle measurements, body posture metrics, and/or temporal sequences of movement data to identify patterns that distinguish correct CPR technique from incorrect performance.

The classification module 104d may implement performance standards integration that evaluates CPR technique against established scoring criteria, utilizing a weighted scoring system where, for example, compression rate may contribute approximately 40% of the overall score, posture analysis may contribute approximately 30%, depth and recoil measurements may contribute approximately 25%, and counting compliance may contribute approximately 5% of the total assessment. These percentage weightings are provided as non-limiting examples, and the classification module 104d may be configured to utilize different weighting distributions based on training requirements, certification standards, and/or user preferences. The system 100 may establish a pass threshold of approximately 80% for overall CPR performance, requiring trainees 114 to demonstrate competency across multiple performance categories to achieve certification standards. This threshold value is provided as a non-limiting example, and the system 100 may be configured to utilize different threshold values based on specific training protocols or certification requirements.

The classification module 104d may leverage the 33 keypoint coordinates with (x, y, visibility) parameters provided by the marking module 104b, utilizing spatial and temporal relationships between these keypoints to extract meaningful biomechanical features relevant to CPR assessment. The machine learning architecture may incorporate heatmap-based CNN outputs as intermediate feature representations, enabling utilization of probabilistic spatial information generated during keypoint localization to inform classification decisions. Feature extraction algorithms may transform raw body movement parameters into higher-level representations that capture the biomechanical characteristics of effective CPR compressions using convolutional neural networks, recurrent neural networks, transformer architectures, and/or custom feature engineering techniques.

With continued reference to FIG. 1, the classification module 104d may generate compression classifications that categorize individual compression cycles into multiple performance categories based on adherence to CPR guidelines. The classification module 104d may implement binary classification schemes that distinguish between correct and incorrect compressions, or may utilize multi-class classification approaches that provide more granular assessment categories such as excellent technique, adequate technique, marginal technique, and/or inadequate technique. The classification module 104d may generate separate classifications for different aspects of CPR performance, such as compression depth adequacy, hand placement accuracy, compression rate compliance, release completeness, and/or overall technique quality, then combine these individual aspect classifications into composite performance scores that provide comprehensive evaluation of each compression cycle.

Embodiments of the classification module 104d may implement supervised learning algorithms trained on labeled datasets containing examples of correct and incorrect CPR compressions performed on various non-mannequin training objects. Training datasets may include body movement parameters extracted from video recordings of CPR training sessions, with each compression cycle labeled by medical professionals or CPR instructors according to established guidelines. The classification module 104d may implement compression cycle detection algorithms that analyze smoothed depth signals and position data to identify individual compression events using peak and trough detection techniques, where local minima may correspond to maximum compression depth and local maxima may correspond to full chest release positions. Temporal filtering and signal processing techniques may eliminate noise artifacts and ensure accurate identification of compression boundaries, enabling precise classification of individual compression events within continuous CPR performance sequences. The training process may involve heatmap-based CNN components learning to generate accurate probabilistic heat maps for keypoint localization, while regression CNN components may learn to predict precise (x, y, visibility) coordinates for a plurality of anatomical keypoints, such as 33 keypoints in some embodiments, though other embodiments may utilize different numbers of keypoints depending on the specific pose estimation architecture. The Stacked Hourglass Network-inspired architecture may be trained using iterative refinement techniques, where multiple hourglass modules progressively improve the accuracy of keypoint detection and feature extraction through repeated processing at different spatial scales. Machine learning algorithms such as support vector machines, random forests, gradient boosting methods, logistic regression, and/or neural network architectures may learn the relationships between body movement parameters and compression quality classifications. The training process may incorporate transfer learning approaches that leverage pre-trained heatmap-based CNN and regression CNN components, fine-tuning these models on CPR-specific datasets to optimize performance for CPR technique assessment requirements.

As shown in FIG. 3, the classification module 104d may perform step 308 by implementing deep learning architectures that automatically learn hierarchical feature representations from the computed body movement parameters. The classification module 104d may implement posture correctness classification algorithms that evaluate the overall body positioning and alignment of the trainee 114 during CPR compressions by analyzing spatial relationships between key anatomical landmarks including shoulders, hips, knees, and hands to assess whether the trainee 114 maintains proper body mechanics throughout the compression sequence.

The classification module 104d may implement specific angle calculations for posture analysis, including elbow lock detection that requires both elbows to maintain angles between, for example, 165 degrees and 180 degrees throughout compressions, indicating proper arm extension and force transmission. Hand-back angle measurements may evaluate the angle between the line from wrist to shoulder and the torso alignment, requiring angles between, for example, 80 degrees and 100 degrees to ensure optimal body weight positioning over the compression target. Perpendicular pushing detection algorithms may analyze the shoulder-to-wrist line angle relative to the vertical axis, maintaining angles between, for example, 80 degrees and 100 degrees to ensure compressions are directed straight downward rather than at oblique angles.

Posture may be classified as correct when the trainee's 114 shoulders are positioned directly over the compression target, the back maintains appropriate curvature, the knees are properly positioned for stability, and the arms remain straight during compression phases. The classification module 104d may identify posture deviations such as lateral body lean, excessive forward or backward positioning, improper knee placement, and/or inadequate arm extension that may reduce compression effectiveness and increase rescuer fatigue. Biomechanical analysis algorithms may evaluate force transmission efficiency based on body alignment, calculating metrics such as shoulder-to-hand alignment angles, torso inclination measurements, and/or weight distribution ratios to assess posture correctness. The classification module 104d may utilize convolutional neural networks that process spatial patterns in hand positioning and body alignment data, recurrent neural networks that analyze temporal sequences of compression cycles, attention mechanisms that focus on the most relevant aspects of the movement data for classification decisions, multi-layer perceptrons, long short-term memory networks, gated recurrent units, and/or transformer models to capture complex relationships between different body movement parameters and their impact on CPR effectiveness. Ensemble methods may combine predictions from multiple neural network architectures to improve classification accuracy and robustness.

The classification module 104d may incorporate temporal analysis capabilities that evaluate sequences of compression cycles to identify patterns and trends in CPR performance over time. Additional action classification algorithms may identify and categorize non-compression activities during the CPR training session, including hands-off periods, repositioning events, and/or technique adjustment phases. Hands-off periods may be detected by analyzing the vertical distance between hand positions and the training object, identifying time intervals when the hands are elevated above threshold distances such as 2 inches, 3 inches, 4 inches, and/or 5 inches from the compression surface. Hands-off events may be classified based on duration, categorizing brief interruptions of less than 2 seconds as normal release phases, intermediate pauses of 2 to 10 seconds as technique adjustments, and/or extended interruptions exceeding 10 seconds as significant breaks in compression delivery. Repositioning detection algorithms may identify when the trainee 114 adjusts hand placement, body position, and/or compression angle during the training session, analyzing movement patterns to distinguish between intentional technique corrections and unintentional position drift. The classification module 104d may analyze the consistency of compression technique across multiple cycles, detect fatigue-related degradation in performance quality, and/or identify learning patterns as the trainee 114 improves their technique during the training session. Sliding window analysis may evaluate compression quality over different time intervals, such as 30-second segments, 1-minute segments, and/or 2-minute segments, to assess sustained performance capability using time series analysis techniques, sequence modeling algorithms, and/or dynamic programming approaches to capture temporal dependencies in the compression classification process.

Referring again to FIG. 1, the classification module 104d may implement adaptive classification algorithms that adjust their decision criteria based on the characteristics of individual trainees 114 or specific training scenarios. Automatic form grading capabilities may provide comprehensive assessment of overall CPR technique quality using machine learning models trained on expert evaluations and clinical outcome data. Composite form grades may combine individual compression quality scores, posture correctness assessments, timing consistency measurements, and/or technique progression indicators into overall performance ratings such as excellent, good, satisfactory, needs improvement, and/or inadequate. Rubric-based grading algorithms may evaluate specific CPR technique components according to established assessment criteria, assigning numerical scores and letter grades based on adherence to medical guidelines and best practices. Machine learning models such as neural networks, decision trees, and/or ensemble methods may automatically generate form grades that correlate with expert human assessments, enabling consistent and objective evaluation of CPR performance across different trainees 114 and training sessions. The classification module 104d may analyze trainee 114 physical attributes, experience level, and/or historical performance data to customize the classification thresholds and feature weighting for each individual. Personalization algorithms may learn the typical movement patterns and performance characteristics of individual trainees 114 over multiple training sessions, enabling more accurate and relevant classification decisions by adjusting classification sensitivity, modifying feature importance weights, and/or applying trainee-specific correction factors based on factors such as body size, arm length, training object type, and/or environmental conditions during the CPR training session.

Embodiments of the classification module 104d may incorporate uncertainty quantification techniques that provide confidence estimates for each compression classification decision using Bayesian neural networks, Monte Carlo dropout methods, ensemble uncertainty estimation, and/or other probabilistic approaches to quantify the reliability of classification predictions. Confidence scores may indicate the certainty of each classification decision, enabling the system 100 to identify cases where additional analysis or human review may be beneficial. Active learning algorithms may identify compression cycles with high classification uncertainty and request additional training data or expert feedback to improve model performance in challenging scenarios. The classification module 104d may generate structured output data in the form of comprehensive lists and tables that document detected compressions with associated timestamps, depth measurements, and/or quality flags for each compression cycle. Compression event tables may include columns for compression sequence number, start timestamp, end timestamp, maximum compression depth, compression duration, release duration, quality classification, confidence score, and/or deviation flags. Timestamp correlation algorithms may precisely align each compression event with the corresponding video frame timing, enabling accurate synchronization between classification results and visual feedback presentation. Quality flags may indicate specific aspects of compression performance, such as adequate depth achieved, proper hand placement maintained, complete release accomplished, symmetric force application, and/or correct body posture sustained. Hierarchical output formatting may organize classification results at multiple levels, including individual compression events, compression sequence segments, and/or overall session summaries. Exportable data formats such as CSV files, JSON structures, XML documents, and/or database records may enable integration with external analysis tools, reporting systems, and/or certification tracking applications.

The classification module 104d may implement multi-modal classification approaches that integrate information from different types of body movement parameters to make more robust classification decisions by combining spatial features derived from hand positioning and body alignment data with temporal features extracted from compression timing and rhythm patterns. Attention mechanisms may automatically determine the relative importance of different parameter types for each classification decision, allowing the model to focus on the most relevant aspects of CPR technique for each individual compression cycle. Feature fusion techniques, multi-stream neural networks, and/or hierarchical classification architectures may effectively combine diverse types of movement data. The classification module 104d may generate detailed performance metrics tables that include statistical summaries such as mean compression depth, standard deviation of compression timing, compression rate consistency scores, hand positioning accuracy percentages, and/or posture compliance ratios. Real-time table updating capabilities may continuously append new compression events to the output data structures as they are detected and classified during live training sessions. Session summary tables may aggregate classification results across the entire training session, providing overall performance statistics, trend analysis, and/or improvement recommendations. Data validation algorithms may verify the consistency and accuracy of output tables, detecting and flagging potential errors in timestamp alignment, depth measurements, and/or classification assignments.

As further shown in FIG. 1, the classification module 104d may incorporate real-time classification capabilities that enable immediate assessment of CPR compressions during live training sessions using optimized machine learning models and efficient inference algorithms to minimize the computational delay between receiving body movement parameters from the computing module 104c and generating classification results. Model compression techniques, quantization methods, and/or hardware acceleration approaches may achieve real-time performance while maintaining classification accuracy. Streaming classification algorithms may process compression data incrementally as it becomes available, providing immediate feedback to the trainee 114 through the mobile application 106 and user interface 106a. Continuous learning capabilities may allow the machine learning model to improve its performance over time based on feedback from trainees 114, instructors, and/or medical professionals by collecting classification results, user feedback, and/or expert annotations to create additional training data that may be used to refine the model parameters and improve classification accuracy. Online learning algorithms, incremental training methods, and/or federated learning approaches may enable the model to adapt to new training scenarios, different types of non-mannequin training objects, and/or evolving CPR guidelines. Reinforcement learning techniques may optimize classification decisions based on the effectiveness of the feedback provided to trainees 114 and the resulting improvements in their CPR performance.

The classification module 104d may implement explainable artificial intelligence techniques that provide interpretable explanations for classification decisions, enabling trainees 114 and instructors to understand the specific aspects of CPR technique that contributed to each classification result. Feature importance scores, attention visualizations, and/or decision pathway explanations may highlight the body movement parameters that most strongly influenced each classification decision. Gradient-based explanation methods, layer-wise relevance propagation, and/or counterfactual analysis techniques may provide detailed insights into the classification process. These explanations may be presented through the mobile application 106 and user interface 106a, helping trainees 114 understand how to improve their CPR technique based on the specific feedback provided by the machine learning model.

Referring to FIG. 1 and FIG. 3, embodiments of the editor module 104e may be configured to map metrics over the standardized video based on the compression classifications received from the classification module 104d, performing step 310 of the method 300, and to generate a feedback video based on the mapped metrics, performing step 312 of the method 300. The editor module 104e may implement various metric mapping techniques that overlay quantitative performance data, visual indicators, and/or analytical annotations onto the standardized video, and may utilize video generation techniques that combine the standardized video with performance metrics to create comprehensive feedback videos that provide visual and analytical guidance to the trainee 114. The editor module 104e may receive input data comprising detected compression events with associated metrics from the classification module 104d, along with the original video frames from the preprocessing module 104a, enabling comprehensive processing of both temporal event data and visual content for feedback generation. In some embodiments, the editor module 104e may utilize computer graphics algorithms, video processing techniques, video encoding algorithms, graphics rendering techniques, multimedia processing approaches, and/or augmented reality approaches to seamlessly integrate performance metrics with the original video content while maintaining visual clarity, high visual quality, and analytical accuracy.

The editor module 104e may implement automated post-processing capabilities that refine and optimize detected compression events before generating visual overlays and feedback content. Duplicate detection and removal algorithms may identify and eliminate spurious compression detections that occur when compression events are detected too close together in time, such as within intervals of less than 0.3 seconds, 0.5 seconds, 0.7 seconds, and/or 1.0 seconds. Temporal filtering techniques may analyze timing patterns of detected compression events and remove duplicate detections that result from noise artifacts, motion blur, and pose estimation uncertainties during rapid movement phases. Statistical analysis methods such as clustering algorithms, outlier detection techniques, and temporal smoothing filters may identify and eliminate compression events that deviate significantly from expected timing patterns and physiological constraints of human CPR performance. Compression event validation algorithms may verify the consistency of detected events against biomechanical models and established CPR timing protocols, rejecting events that violate anatomical movement constraints or exceed realistic compression frequencies.

Event boundary refinement algorithms may precisely determine the start and end timestamps of compression cycles to enable accurate synchronization between detected events and corresponding video frames. Signal processing techniques such as derivative analysis, peak detection refinement, and gradient-based boundary detection may identify the exact temporal boundaries of compression phases, release phases, and transition periods within each compression cycle. Multi-scale temporal analysis may examine compression events at different time resolutions, including frame-level analysis at 30 frames per second, sub-frame interpolation for higher temporal precision, and sliding window analysis over multiple compression cycles to refine event boundaries. Machine learning-based boundary detection algorithms trained on labeled datasets of compression events may automatically identify optimal start and end points for each compression cycle based on characteristic movement patterns and velocity profiles. Adaptive boundary refinement may adjust the precision and sensitivity of event detection based on input video quality, the consistency of the trainee's 114 compression technique, and the specific characteristics of the non-mannequin training object being used.

Structured event logging and data preparation processes may organize compression event data and associated metrics into standardized formats suitable for overlay generation and feedback presentation. Comprehensive event logs may document each detected compression cycle with associated metadata including event sequence numbers, precise start and end timestamps measured in milliseconds, maximum compression depth measurements in centimeters and inches, compression duration and release duration in seconds, compression rate calculations in compressions per minute, hand positioning coordinates in pixel and real-world units, body posture assessment scores, and quality classification labels. Data structure generation algorithms may organize event information into hierarchical formats such as nested dictionaries, structured arrays, and database-compatible records that facilitate efficient access and manipulation during overlay generation. Data validation and consistency checking algorithms may verify the integrity and completeness of event logs, identifying missing data fields, temporal inconsistencies, and measurement anomalies that require correction before overlay processing. Data export capabilities may generate event logs in various formats such as CSV, JSON, XML, and custom binary formats that enable integration with external analysis tools and reporting systems.

Spatial metric mapping techniques may position performance indicators at specific locations within the video frame corresponding to relevant anatomical landmarks or training object features. Compression depth measurements may be overlaid directly above the hand positions of the trainee 114, displaying numerical values that indicate the measured depth for each compression cycle in real-time as the video plays, utilizing precise coordinate positioning algorithms that account for hand movement trajectories and maintain consistent text placement relative to anatomical landmarks. Feedback embossing capabilities may systematically overlay key performance metrics onto individual video frames using computer vision drawing functions and graphics rendering techniques. For each detected compression event and video frame, the editor module 104e may emboss compression depth measurements displayed in centimeters and inches using standardized text formatting, compression count indicators that track the cumulative number of completed compression cycles, visual progress bars that show current compression depth relative to target depth ranges established by CPR guidelines, and symmetry and hand position alerts that highlight deviations from proper technique. OpenCV-style drawing functions and graphics libraries may implement precise overlay generation, including text rendering functions for numerical displays, rectangle drawing functions for progress bars and target zones, line drawing functions for trajectory indicators and alignment guides, circle drawing functions for anatomical landmark highlighting, and polygon drawing functions for complex geometric overlays. Dynamic positioning algorithms may track the movement of the trainee's 114 hands throughout the compression sequence and maintain consistent placement of depth metrics relative to hand positions, utilizing coordinate transformation techniques to ensure that mapped metrics remain accurately positioned even when the trainee 114 moves within the video frame or when camera perspective changes occur during recording.

Frame-by-frame video generation workflows may systematically process each video frame to create annotated feedback videos with embedded performance metrics and visual guidance. Video processing pipelines may read individual frames from the standardized video, apply metric overlays and annotations based on prepared event logs, and write annotated frames to generate new feedback video files with embedded performance information. Frame buffer management systems may efficiently handle large video files by processing frames in batches, utilizing memory optimization techniques such as frame caching, progressive loading, and streaming processing to manage computational resources during video generation. Video encoding algorithms may compress annotated frames into standard video formats such as MP4, AVI, MOV, and WebM while preserving the visual quality of overlaid metrics and maintaining synchronization between audio and video components. Multi-threaded processing capabilities may parallelize frame annotation tasks across multiple processor cores, enabling efficient generation of feedback videos even for extended training sessions with thousands of individual frames. Hardware acceleration techniques such as GPU computing, specialized video processing units, and dedicated encoding hardware may achieve real-time or near-real-time feedback video generation during live training sessions.

Advanced drawing and annotation techniques may utilize computer vision libraries and graphics frameworks to create precise and visually appealing performance overlays. Text rendering algorithms may display compression depth measurements using configurable font sizes, colors, and positioning, with automatic text scaling based on video resolution and viewing distance requirements. Rectangle drawing functions may create progress bars that visually represent compression depth relative to target ranges, with color-coded filling that transitions from red for insufficient depth to green for adequate depth, and yellow for excessive depth that may indicate over-compression. Line drawing capabilities may create trajectory indicators showing the path of hand movement during compression cycles, alignment guides that help visualize proper hand positioning relative to anatomical landmarks, and reference grids that provide spatial context for depth and positioning measurements. Circle and ellipse drawing functions may highlight anatomical landmarks such as hand positions, shoulder joints, and compression target areas, with dynamic sizing and coloring based on the accuracy and quality of pose estimation results. Polygon drawing capabilities may create complex geometric overlays such as body posture assessment zones, compression force vector indicators, and multi-point trajectory paths that show the complete movement pattern of the trainee's 114 hands throughout multiple compression cycles.

Color-coded metric mapping schemes may use different colors to represent various performance categories and quality levels based on compression classifications. Green coloring may be assigned to metrics associated with correct compression techniques, yellow coloring for marginal performance, and red coloring for incorrect or inadequate compressions. Gradient color mapping may provide more nuanced visual feedback by using color intensity variations to represent the degree of deviation from optimal performance parameters. For example, darker shades of red may indicate more severe technique errors and lighter shades may represent minor deviations from established guidelines. Customizable color schemes may allow instructors or trainees 114 to select preferred color mappings based on personal preferences or accessibility requirements.

Temporal metric mapping capabilities may display performance trends and patterns across multiple compression cycles within the training session. Timeline visualization techniques may show compression rate consistency over time, displaying horizontal graph or chart overlays that indicate whether the trainee 114 maintains the recommended compression frequency throughout the session. Fatigue indicators may highlight periods where compression quality degrades due to physical exhaustion, using visual cues such as changing opacity, pulsing effects, and warning symbols to draw attention to performance decline. Sliding window analysis visualization may show rolling averages of compression parameters over configurable time intervals, such as 30-second windows, 1-minute windows, and 2-minute windows.

Multi-layered metric mapping approaches may simultaneously display multiple types of performance data without creating visual clutter or confusion. Transparency effects and layering techniques may overlay compression depth metrics, hand positioning accuracy indicators, compression rate measurements, and body posture assessments in a hierarchical manner that allows selective viewing of different metric types. Interactive controls may enable users to toggle the visibility of specific metric categories, allowing focused analysis of particular aspects of CPR performance. Adaptive display algorithms may automatically adjust the prominence and positioning of different metrics based on their relevance to the current phase of the compression cycle or the specific performance issues identified by the classification module 104d.

Geometric overlay techniques may use shapes, lines, and graphical elements to represent performance metrics and provide visual guidance for technique improvement. Target zones may be overlaid on the training dummy 112 to indicate the optimal hand placement area, using circular or rectangular outlines that help the trainee 114 visualize proper positioning. Trajectory mapping may display the path of hand movement during compression cycles, using curved lines or arrows to show the actual movement pattern compared to the ideal compression trajectory. Vector graphics may display force direction indicators that show the angle and magnitude of applied compression force based on the body movement parameters computed by the computing module 104c.

Textual metric mapping capabilities may display numerical values, performance scores, and descriptive feedback directly within the video frame. Dynamic text overlays may show real-time compression counts, elapsed time measurements, and cumulative performance scores that update continuously as the video progresses. Font scaling and positioning algorithms may ensure that textual metrics remain legible across different video resolutions and display devices. Multi-language support may display metric labels and descriptions in various languages based on user preferences or regional requirements. Text formatting techniques such as bold highlighting, color coding, and animation effects may emphasize important performance milestones or critical technique errors.

Layered video composition techniques may combine multiple visual elements into a unified feedback video presentation. Base video layers may contain the standardized video footage of the trainee 114 performing CPR on the training dummy 112, overlay layers may contain the mapped performance metrics, annotation layers may provide instructional guidance, and interface layers may include interactive controls and navigation elements. Alpha blending algorithms may control the transparency and visibility of different video layers, enabling the creation of composite feedback videos that display multiple types of information without obscuring the underlying CPR performance footage. Dynamic layer management may automatically adjust the visibility and prominence of different video layers based on the current playback position, performance quality, and user interaction preferences.

Temporal synchronization mechanisms may ensure accurate alignment between the mapped performance metrics and the corresponding video frames throughout the feedback video generation process. Frame-accurate synchronization algorithms may match each performance measurement with the precise video frame where the corresponding body movement or compression event occurred. Timestamp correlation techniques may maintain synchronization between the original video capture time, the pose estimation results from the marking module 104b, the computed parameters from the computing module 104c, and the classification results from the classification module 104d. Drift correction algorithms may compensate for minor timing discrepancies that accumulate during the video processing pipeline, ensuring that the feedback video maintains accurate temporal alignment throughout the entire training session duration.

Comparative metric mapping and feedback video generation techniques may display the trainee's 114 performance alongside reference standards, benchmark values, reference demonstrations, expert technique examples, and peer performance comparisons. Guideline ranges for compression depth may be overlaid, showing both measured values and acceptable ranges specified by CPR protocols such as those established by the American Heart Association or other medical organizations. Side-by-side comparison displays may show the trainee's 114 technique parameters next to optimal reference values, using bar charts, numerical displays, and percentage indicators to quantify performance gaps. Split-screen feedback videos may show the trainee's 114 CPR technique on one side and an expert demonstration on the other side, enabling direct visual comparison of body positioning, compression depth, and timing patterns through synchronized playback and aligned overlay metrics. Overlay comparison videos may superimpose ideal technique trajectories over the trainee's 114 actual movements, highlighting deviations and providing visual guidance for improvement through color-coded trajectory lines, deviation magnitude indicators, and corrective arrow overlays. Advanced video composition techniques may combine multiple video sources, overlay layers, and annotation elements into unified comparison presentations, utilizing alpha blending algorithms, layer masking techniques, and picture-in-picture arrangements to create comprehensive comparative feedback experiences. Historical comparison mapping may display the trainee's 114 current performance relative to their previous training sessions, enabling progress tracking and improvement assessment over time through trend line overlays, performance delta indicators, and skill progression visualizations. Anonymized peer comparison features may show how the trainee's 114 performance compares to other users with similar experience levels, providing context and benchmarking opportunities through statistical overlay displays, percentile rankings, and normalized performance metrics.

Adaptive metric mapping and feedback video generation algorithms may customize the display of performance indicators and the content, presentation style, and instructional approach based on the skill level, experience, learning objectives, and individual characteristics and learning needs of each trainee 114. The editor module 104e may analyze the trainee's 114 historical performance data, current skill assessment, and learning preferences to determine the most appropriate level of detail and complexity for metric displays and the most effective feedback presentation format. For novice trainees 114, basic performance indicators such as compression depth and rate may be emphasized, while for advanced trainees 114, more sophisticated metrics such as compression waveform analysis, release velocity measurements, and biomechanical efficiency indicators may be displayed. For visual learners, graphical overlays, color-coded performance indicators, and animated technique demonstrations may be emphasized, while for auditory learners, feedback videos with detailed verbal explanations and audio-based guidance may be generated. Progressive disclosure techniques may gradually introduce more complex metrics as the trainee 114 demonstrates mastery of fundamental CPR techniques. Adaptive difficulty scaling may adjust the complexity and detail level of feedback content based on the trainee's 114 demonstrated proficiency and improvement rate over multiple training sessions. Personalized feedback videos may focus on the specific performance weaknesses identified for each individual trainee 114, providing targeted instruction and practice recommendations.

Adaptive video quality optimization techniques may adjust the encoding parameters and visual characteristics of the feedback video based on the intended viewing platform and user requirements. Feedback videos may be generated with different resolution settings, compression levels, and frame rates to accommodate various display devices such as smartphones, tablets, desktop computers, and large-screen displays used in training facilities. Multi-bitrate encoding may create multiple versions of the feedback video with different quality levels, enabling adaptive streaming through the mobile application 106 based on available network bandwidth and device capabilities. Perceptual video encoding techniques may optimize compression settings to preserve the visual clarity of performance metrics and annotations while reducing file sizes for efficient transmission and storage.

Real-time metric mapping and feedback video generation capabilities may enable immediate visualization of performance data and creation and delivery of performance assessment videos during live CPR training sessions. Streaming video processing techniques, low-latency graphics rendering, and parallel computing resources may minimize the delay between compression classification by the classification module 104d and the display of corresponding metrics on the video feed and the availability of the completed feedback video through the mobile application 106. Real-time frame processing pipelines may apply overlay generation algorithms to live video streams, utilizing optimized drawing functions, efficient memory management, and hardware-accelerated graphics processing to achieve frame rates suitable for real-time feedback delivery. Buffering and synchronization algorithms may ensure that mapped metrics remain accurately aligned with the corresponding video frames even when processing delays occur, utilizing adaptive buffering strategies, timestamp correlation techniques, and predictive frame alignment to maintain temporal accuracy. Incremental video generation algorithms may create feedback video segments in real-time as the training session progresses, enabling immediate review of recent performance without waiting for the entire session to complete, through segment-based processing, progressive video assembly, and streaming video output generation. Technical implementation approaches may include multi-threaded processing architectures that separate overlay generation from video encoding tasks, frame queue management systems that optimize data flow between processing stages, and adaptive quality control algorithms that adjust overlay complexity based on available computational resources and real-time performance requirements. Live feedback overlays may display performance metrics and guidance directly on the video stream from the capturing device 102, providing immediate visual feedback to the trainee 114 during the CPR exercise through real-time graphics overlay systems, augmented reality display techniques, and heads-up display implementations. Hardware acceleration techniques such as GPU processing, specialized video processing units, and distributed computing resources may achieve real-time performance while maintaining high-quality metric visualization. Buffering and caching mechanisms may ensure smooth playback of real-time feedback videos even when network conditions or processing loads fluctuate, utilizing adaptive streaming protocols, quality-based encoding selection, and predictive resource allocation algorithms.

Interactive metric mapping and feedback video generation features may allow trainees 114 and instructors to manipulate and explore performance data through the mobile application 106 and user interface 106a. Zoom and pan capabilities may enable detailed examination of specific compression cycles or body movement patterns within the mapped video. Playback control integration may allow users to pause, slow down, and step through the video frame-by-frame while maintaining synchronized display of performance metrics. Clickable hotspots, timeline scrubbers, and performance metric toggles may allow trainees 114 to interact with the feedback video through the user interface 106a of the mobile application 106. Feedback videos may be generated with embedded chapter markers that correspond to different phases of the CPR training session, such as initial positioning, compression cycles, and technique transitions. Annotation tools may enable instructors to add custom comments, markers, and highlighting to specific portions of the mapped video for educational purposes. Branching video structures may allow users to navigate between different analysis views, such as switching between overall performance summaries and detailed examination of specific compression cycles. Feedback videos may be created with embedded quiz questions, technique challenges, and interactive exercises that engage the trainee 114 in active learning while reviewing their performance.

Multi-modal feedback generation capabilities may combine visual overlays with audio commentary, haptic feedback cues, and textual annotations to create comprehensive learning experiences. Synthetic audio narration may describe the trainee's 114 performance in real-time, highlighting correct techniques and providing corrective guidance for identified errors. Text-to-speech algorithms may convert performance analysis results from the analysis module 104f into spoken feedback, enabling hands-free review of CPR technique assessment. Feedback videos may be generated with embedded audio cues such as metronome beats to help trainees 114 understand proper compression timing, warning sounds to indicate technique errors, and congratulatory sounds to reinforce correct performance. Multi-language feedback videos may provide audio commentary and textual annotations in various languages based on user preferences or regional training requirements.

Collaborative metric mapping and feedback video generation features may enable multiple users to contribute to and benefit from the feedback creation process. Collaborative features may allow multiple users to view and discuss the mapped metrics simultaneously through shared viewing sessions or remote training scenarios. Feedback videos may be generated with embedded annotation tools that allow instructors to add custom comments, technique tips, and corrective guidance at specific timestamps within the video. Collaborative review sessions may enable multiple trainees 114 to view and discuss feedback videos simultaneously through the mobile application 106, enabling peer learning and group analysis of CPR techniques. Feedback videos may be created with embedded discussion threads, comment sections, and rating systems that facilitate community-based learning and knowledge sharing. Instructor dashboard videos may provide comprehensive overviews of multiple trainees' 114 performance, enabling efficient assessment and guidance for training programs with large numbers of participants.

Statistical metric mapping techniques may display aggregate performance data and trend analysis alongside individual compression measurements. Statistical summaries such as mean compression depth, standard deviation of compression timing, and correlation coefficients between different performance parameters may be overlaid. Data visualization techniques such as histograms, scatter plots, and trend lines may represent the distribution and relationships of performance metrics across the entire training session. Predictive metric mapping may use machine learning algorithms to forecast performance trends and display projected outcomes based on current technique patterns. Confidence intervals and uncertainty estimates may be generated for mapped metrics to help trainees 114 and instructors understand the reliability and precision of the performance measurements.

Advanced feedback video generation techniques may incorporate machine learning algorithms and artificial intelligence to enhance the educational value and effectiveness of the generated content. Computer vision algorithms may automatically identify the most instructive moments within the training session and create highlight reels that focus on key learning opportunities. Natural language processing techniques may generate automated performance summaries, technique recommendations, and personalized improvement plans that are embedded within the feedback videos. Predictive analytics may identify potential technique problems before they become established patterns, generating proactive feedback videos that help trainees 114 avoid developing incorrect CPR habits. Adaptive learning algorithms may continuously refine the feedback video generation process based on user engagement metrics, learning outcomes, and instructor feedback to optimize the educational effectiveness of the generated content.

Referring to FIG. 1 and FIG. 3, embodiments of the analysis module 104f may be configured to identify deviations from CPR guidelines based on the feedback video received from the editor module 104e, performing step 314 of the method 300, and to generate analysis results based on the identified deviations, performing step 316 of the method 300. The analysis module 104f may implement various analytical techniques, statistical methods, and/or pattern recognition algorithms to systematically evaluate the trainee's 114 CPR performance against established medical standards and protocols established by organizations such as the American Heart Association, European Resuscitation Council, and/or other medical authorities using rule-based analysis systems, machine learning algorithms, and/or expert system approaches, achieving 96% consistency between automated assessment scores and expert human evaluation with posture fault detection rates exceeding 90% across test sessions in some embodiments.

The analysis module 104f may implement comprehensive guideline comparison algorithms that systematically evaluate CPR performance against established benchmarks and acceptable ranges specified in current protocols. These algorithms analyze compression depth measurements to identify deviations from recommended ranges for adult, pediatric, and/or infant CPR, such as compressions falling outside the recommended adult compression depth range of approximately 2.0 to 2.4 inches, 1.8 to 2.4 inches, 1.5 to 2.5 inches, and/or 1.0 to 3.0 inches, depending on specific guidelines being applied. The analysis module 104f may evaluate compression rate consistency against recommended ranges of approximately 100 to 120 compressions per minute, 95 to 110 compressions per minute, 90 to 120 compressions per minute, and/or 80 to 130 compressions per minute, identifying periods where the trainee's 114 compression rate deviates significantly from target ranges. Hand positioning accuracy may be assessed by comparing the trainee's 114 hand placement with the recommended compression zone on the lower half of the breastbone, identifying lateral or longitudinal displacement errors that may reduce compression effectiveness.

The analysis module 104f may incorporate temporal deviation analysis capabilities that examine consistency and timing patterns throughout the training session, identifying periods of performance degradation that may indicate trainee 114 fatigue, loss of concentration, and/or technique deterioration over time. Compression release patterns may be analyzed to identify incomplete chest recoil between compressions, which may reduce the effectiveness of subsequent compressions and impair venous return. The duty cycle of compression and release phases may be evaluated to identify deviations from the recommended 50% compression and 50% release timing that optimizes blood flow during CPR. Sliding window analysis techniques may evaluate performance consistency over different time intervals, such as 30-second segments, 1-minute segments, 2-minute segments, and/or 5-minute segments, to identify both short-term technique variations and longer-term performance trends.

Multi-parameter deviation analysis may examine relationships and interactions between different aspects of CPR performance to identify complex technique problems that may not be apparent when analyzing individual parameters in isolation. The analysis module 104f may analyze correlations between compression depth and hand positioning to identify cases where improper hand placement leads to inadequate compression depth or excessive force application, evaluate relationships between compression rate and compression depth consistency, and/or assess interactions between body posture and compression effectiveness. Multivariate statistical analysis techniques such as principal component analysis, cluster analysis, and/or regression analysis may identify patterns of correlated deviations that indicate systematic technique problems requiring targeted corrective instruction.

As shown in FIG. 3, the analysis module 104f may perform step 314 by implementing severity classification algorithms that categorize identified deviations based on their potential impact on CPR effectiveness and patient outcomes. Deviations may be classified as minor, moderate, and/or major based on the magnitude of deviation from established guidelines and the clinical significance of each parameter. For example, compression depth deviations of less than 0.2 inches, 0.3 inches, 0.4 inches, and/or 0.5 inches from the target range may be classified as minor deviations, while deviations exceeding 0.5 inches, 0.7 inches, 1.0 inches, and/or 1.2 inches may be classified as major deviations requiring immediate corrective action. Weighted scoring systems may account for the relative importance of different CPR parameters, assigning higher severity scores to deviations in compression depth and rate compared to minor variations in hand positioning and body posture, utilizing evidence-based weighting factors derived from clinical research studies that quantify the relationship between specific technique parameters and patient survival outcomes.

The analysis module 104f may incorporate adaptive and contextual deviation detection algorithms that adjust analysis criteria based on individual trainee 114 characteristics, training scenarios, and/or non-mannequin training objects used during the CPR exercise. Physical characteristics such as height, arm length, and/or body proportions may be analyzed to customize deviation detection thresholds for hand positioning and body posture assessments. Analysis parameters may be adjusted based on the type of training dummy 112 or non-mannequin training object being used, accounting for differences in compressibility, size, and/or feedback characteristics that may affect the interpretation of compression measurements. Learning algorithms may adapt deviation detection criteria based on the trainee's 114 historical performance data, experience level, and/or improvement patterns observed over multiple training sessions, utilizing machine learning techniques such as adaptive thresholding, personalized baseline establishment, and/or dynamic reference adjustment.

Contextual deviation analysis may consider specific circumstances and conditions present during the CPR training session when evaluating performance deviations. Environmental factors such as lighting conditions, camera positioning, and/or background interference that may affect the accuracy of pose estimation and movement analysis performed by the marking module 104b and computing module 104c may be analyzed. Equipment-related factors such as the characteristics of the capturing device 102, video quality settings, and/or wireless communication network 108 performance that may introduce measurement uncertainties may be accounted for. Training scenario factors such as the duration of the CPR exercise, the presence of distractions, and/or the complexity of the training protocol may be considered when interpreting performance deviations. Uncertainty quantification techniques may provide confidence estimates for each identified deviation, helping trainees 114 and instructors understand the reliability and precision of the analysis results.

Progressive deviation analysis capabilities may track the evolution of technique problems over time and identify patterns of improvement and deterioration in CPR performance. Performance trends across multiple training sessions may be analyzed to identify persistent technique problems that require focused remedial instruction. Longitudinal analysis techniques may compare current performance with historical baselines established for each individual trainee 114, identifying both improvements and regressions in technique quality. Time series analysis methods such as trend detection, change point analysis, and/or seasonal decomposition may characterize the temporal patterns of performance deviations and identify factors that contribute to technique variability. Predictive analysis algorithms may forecast future performance trends based on current deviation patterns, enabling proactive intervention and targeted training recommendations.

Comprehensive deviation documentation and reporting capabilities may generate detailed analysis results based on the identified deviations, performing step 316 of the method 300. Structured deviation reports may categorize identified problems by type, severity, frequency, and/or temporal occurrence within the training session. Quantitative deviation metrics such as deviation magnitude, deviation frequency, deviation duration, and/or deviation consistency scores may provide objective measures of technique quality. Statistical analysis techniques may calculate descriptive statistics, confidence intervals, and/or significance tests for the identified deviations, enabling evidence-based assessment of performance quality. Critical failure points may be identified by analyzing sequences of body movement parameters that consistently lead to incorrect compression classifications. Comprehensive aggregate statistics processing may calculate performance summaries including average compression depth measurements, total compression counts, compression rate consistency metrics, compression depth variance calculations, hand positioning accuracy percentages, elbow angle compliance ratios, and/or overall technique quality scores across the entire training session. Comparative analysis reports may benchmark the trainee's 114 performance against established norms, peer performance data, and/or expert technique demonstrations, providing context for the identified deviations and highlighting areas for improvement.

Specialized error detection algorithms may identify and categorize specific types of technique deviations based on established CPR guidelines and safety protocols. The analysis module 104f may implement a comprehensive error detection taxonomy that organizes identified deviations into multiple categories including compression-related errors, symmetry and hand placement errors, posture and form errors, timing and sequence errors, and video detection quality flags. Compression-related errors may include shallow compression detection by identifying compression cycles where the measured depth falls below minimum recommended thresholds, such as compressions measuring less than 1.8 inches, 2.0 inches, 2.2 inches, and/or 2.4 inches for adult CPR protocols, depending on the specific guidelines being applied. Excessively deep compression errors may be identified by detecting compression cycles that exceed safe maximum thresholds, such as compressions measuring greater than 2.4 inches, 2.6 inches, 2.8 inches, and/or 3.0 inches, which may indicate over-compression that could potentially cause injury. Incomplete release detection algorithms may analyze the return trajectory of hand positions between compression cycles, identifying cases where the hands do not return to the full upward position and fail to allow complete chest recoil. Irregular compression rate errors may be detected by calculating average compressions per minute and identifying performance that falls outside target ranges, such as compression rates below 90, 95, 100, and/or 105 compressions per minute or above 110, 115, 120, and/or 125 compressions per minute. Skipped compression detection algorithms may identify periods when compressions were not performed during expected intervals, analyzing temporal gaps in compression activity that exceed acceptable pause durations of 2 seconds, 3 seconds, 5 seconds, and/or 10 seconds between compression cycles.

Symmetry and hand placement error detection capabilities may evaluate the spatial accuracy and coordination of hand positioning throughout the CPR training session. Hand drift detection algorithms may monitor lateral movement of one or both hands beyond acceptable distances from the compression centerline, identifying drift errors when hand positions deviate by more than 0.5 inches, 1.0 inches, 1.5 inches, and/or 2.0 inches from the target compression zone. Uneven pressure application may be detected by analyzing differences in compression depth between left and right hand positions, identifying imbalanced effort when depth measurements differ by more than 0.2 inches, 0.3 inches, 0.4 inches, and/or 0.5 inches between the two hands during individual compression cycles. Hand crossing detection algorithms may identify instances when the trainee's 114 hands cross over each other during compression movements, analyzing the relative positions of left and right hand landmarks to detect crossing events that may compromise compression effectiveness. Geometric analysis techniques may assess hand crossing by calculating the horizontal displacement between left and right wrist positions and identifying crossing events when the relative positions indicate that the hands have moved beyond their normal spatial boundaries. Hand crossing frequency and duration may be tracked to assess the severity and persistence of this technique error throughout the training session.

Posture and form error detection algorithms may evaluate body mechanics and positioning compliance with established CPR technique standards. Elbow lock compliance may be detected by analyzing elbow angle measurements throughout compression cycles, identifying unlocked elbow errors when joint angles deviate from the target straight-arm position by more than 5 degrees, 10 degrees, 15 degrees, and/or 20 degrees from the optimal 180-degree extension.

The analysis module 104f may implement detailed feedback logic that provides specific guidance based on performance ranges, such as, for example, generating feedback messages when compression rates fall below approximately 100 compressions per minute with recommendations to increase compression frequency, or when compression rates exceed approximately 120 compressions per minute with guidance to reduce compression speed. These specific compression rate thresholds are provided as non-limiting examples, and the analysis module 104f may be configured to utilize different threshold values based on training requirements, certification standards, and/or user preferences.

Torso sway detection algorithms may monitor excessive side-to-side or forward-backward upper body movement during compression activities, analyzing the displacement of shoulder and torso landmarks to identify sway errors that exceed acceptable movement thresholds of 1 inch, 2 inches, 3 inches, and/or 4 inches from the baseline position. Shoulder misalignment errors may be detected by evaluating whether the trainee's 114 shoulders remain positioned directly over the hands during compression cycles, calculating alignment deviations and identifying misalignment when shoulder positions deviate by more than 2 inches, 3 inches, 4 inches, and/or 5 inches from the optimal vertical alignment over the compression target. Vector analysis techniques may assess force transmission efficiency based on body alignment measurements, identifying posture deviations that may reduce compression effectiveness and increase rescuer fatigue during extended CPR performance.

Timing and sequence error detection capabilities may identify rhythm irregularities and temporal inconsistencies in CPR compression delivery. Compression pause detection algorithms may identify gaps between compressions that exceed acceptable durations, flagging pause errors when intervals between compression cycles exceed 1 second, 2 seconds, 3 seconds, and/or 5 seconds beyond the expected rhythm timing. Irregular rhythm errors may be detected by analyzing variation in compression timing across multiple cycles, identifying rhythm inconsistencies when timing variations exceed acceptable limits of 10%, 15%, 20%, and/or 25% from the target compression interval.

The analysis module 104f may implement scoring algorithms that calculate weighted performance metrics, where, for example, compression rate performance may contribute approximately 40% to the overall assessment score, posture compliance may contribute approximately 30%, depth and recoil measurements may contribute approximately 25%, and counting accuracy may contribute approximately 5% to the final evaluation. These percentage weightings are provided as non-limiting examples, and the analysis module 104f may be configured to utilize different weighting distributions based on training requirements, certification standards, and/or user preferences.

Double-counting prevention algorithms may identify and eliminate spurious compression detections caused by motion artifacts, pose estimation noise, and/or signal processing anomalies, utilizing temporal filtering techniques and biomechanical constraint validation to distinguish genuine compression events from false positive detections. Statistical outlier detection methods may identify compression events that deviate significantly from expected timing patterns, removing duplicate detections that occur within unrealistic time intervals of less than 0.3 seconds, 0.5 seconds, 0.7 seconds, and/or 1.0 seconds between consecutive events. Sequence validation algorithms may verify the logical consistency of detected compression cycles, ensuring that each compression event includes appropriate compression and release phases with realistic duration and amplitude characteristics.

Video and detection quality assessment capabilities may monitor the reliability and accuracy of the pose estimation and movement analysis processes throughout the CPR training session. Landmark tracking loss events may be detected by monitoring the confidence scores and visibility parameters provided by the marking module 104b, identifying quality degradation when key anatomical landmarks cannot be reliably tracked for extended periods exceeding 1 second, 2 seconds, 3 seconds, and/or 5 seconds of continuous frames. Tracking quality assessment algorithms may evaluate the consistency and stability of landmark detection across consecutive video frames, flagging quality issues when landmark position variations exceed expected movement patterns and when confidence scores fall below acceptable thresholds of 0.5, 0.6, 0.7, and/or 0.8 on normalized confidence scales. Camera angle quality issues may be detected by analyzing the visibility and spatial relationships of key anatomical landmarks, identifying viewing angle problems when critical body parts are occluded, partially visible, and/or positioned at suboptimal angles for accurate measurement. Body visibility assessment algorithms may calculate the percentage of required anatomical landmarks that are successfully detected and tracked, generating camera angle warnings when visibility falls below acceptable thresholds of 70%, 80%, 85%, and/or 90% of the essential landmarks needed for comprehensive CPR analysis. Geometric analysis techniques may assess measurement accuracy based on camera positioning, identifying scenarios where perspective distortion, viewing angle limitations, and/or distance factors may compromise the precision of compression depth calculations and body positioning assessments.

Real-time deviation analysis capabilities may enable immediate identification of technique problems during live CPR training sessions. Streaming data processing techniques and low-latency analysis algorithms may minimize the delay between receiving feedback video data from the editor module 104e and generating deviation analysis results. Incremental analysis approaches may update deviation assessments continuously as new performance data becomes available throughout the training session. Immediate alerts and notifications may be provided through the mobile application 106 and user interface 106a when significant deviations are detected, enabling real-time corrective guidance for the trainee 114. Comprehensive error taxonomy classification may organize detected deviations into hierarchical categories including compression-related errors, symmetry and hand placement errors, posture and form errors, timing and sequence errors, and/or video detection quality flags, enabling systematic assessment and targeted feedback delivery. Adaptive alert thresholds may adjust the sensitivity of real-time deviation detection based on the trainee's 114 skill level, training objectives, and/or instructor preferences.

Evidence-based deviation analysis may incorporate current medical research and clinical guidelines to ensure that the analysis criteria reflect the most up-to-date understanding of effective CPR techniques. Databases of CPR research studies, clinical trials, and/or expert consensus statements may be accessed to maintain current knowledge of best practices and recommended techniques. Guideline update mechanisms may automatically incorporate new CPR protocol revisions and research findings into the deviation analysis algorithms. Meta-analysis techniques may synthesize findings from multiple research studies to establish evidence-based thresholds and criteria for deviation detection. Comprehensive error frequency tracking may maintain statistical records of detected deviations across multiple training sessions, enabling identification of persistent technique problems and assessment of improvement patterns over time. Expert system approaches may encode the knowledge and decision-making processes of experienced CPR instructors and medical professionals, enabling sophisticated analysis of complex technique problems that may require nuanced interpretation.

Multi-dimensional deviation analysis capabilities may examine CPR performance from multiple perspectives and analytical frameworks to provide comprehensive assessment of technique quality. Biomechanical analysis may evaluate the efficiency and effectiveness of force transmission during compression cycles, identifying deviations in body mechanics that may reduce compression effectiveness. Physiological modeling approaches may estimate the hemodynamic effects of observed technique deviations, providing insights into the potential clinical impact of identified problems. Ergonomic analysis may assess the sustainability and safety of the trainee's 114 CPR technique, identifying deviations that may lead to rescuer fatigue and injury during extended resuscitation efforts. Comprehensive error summary reports may provide statistical breakdowns of detected deviations by category, severity level, temporal distribution, and/or frequency of occurrence, enabling systematic assessment of overall technique quality and identification of priority areas for improvement. Simulation-based analysis may model the effects of identified deviations on patient outcomes, providing educational context for the importance of proper technique adherence.

Referring to FIG. 3, the analysis module 104f may perform steps 314 and 316 by implementing collaborative deviation analysis features that enable multiple experts, instructors, and/or experienced practitioners to contribute to the analysis process and validation of results. Interfaces may allow medical professionals to review and validate the automatically identified deviations, ensuring the accuracy and clinical relevance of the analysis results. Consensus-building algorithms may combine input from multiple reviewers to establish authoritative assessments of technique quality and deviation significance. Collaborative annotation and discussion of identified deviations may be enabled through the mobile application 106, facilitating knowledge sharing and educational dialogue among training participants. Peer review mechanisms may allow experienced trainees 114 and certified instructors to contribute to the analysis process, creating opportunities for collaborative learning and technique refinement.

Referring to FIG. 1 and FIG. 3, embodiments of a feedback module may be configured to provide performance feedback to the trainee 114 based on the analysis results received from the analysis module 104f, performing step 318 of the method 300. The feedback module may implement various feedback delivery mechanisms, presentation formats, and/or interactive features to communicate performance assessment information to the trainee 114 through the mobile application 106 and user interface 106a. The feedback module may utilize multi-modal feedback approaches that combine visual displays, audio notifications, haptic responses, and/or textual summaries to create comprehensive learning experiences that accommodate different learning preferences and training environments, processing the analysis results to generate personalized feedback content that addresses the specific performance deviations and improvement opportunities identified for each individual trainee 114.

The feedback module may implement real-time feedback delivery capabilities that provide immediate performance guidance to the trainee 114 during live CPR training sessions. The feedback module may receive analysis results from the analysis module 104f and generate instant feedback notifications that appear on the user interface 106a of the mobile application 106 while the trainee 114 performs CPR compressions on the training dummy 112. The feedback module may utilize low-latency processing algorithms and optimized communication protocols to minimize the delay between deviation detection and feedback presentation, enabling the trainee 114 to make immediate technique corrections during the training exercise. In some cases, the feedback module may implement adaptive feedback timing that adjusts the frequency and intensity of real-time notifications based on the trainee's 114 skill level, learning progress, and/or concentration requirements. The feedback module may be configured to generate real-time audio prompts during the CPR training session to guide the trainee through proper compression technique based on the analysis results. The feedback module may provide real-time audio cues such as verbal instructions, compression timing beats, and/or corrective prompts that guide the trainee 114 through proper CPR technique without requiring visual attention to the computing device 110.

The feedback module may incorporate visual feedback presentation techniques that display performance information through graphical overlays, charts, progress indicators, and/or color-coded status displays on the user interface 106a. The feedback module may generate performance dashboards that show real-time metrics such as compression depth, compression rate, hand positioning accuracy, and/or overall technique scores in easily interpretable visual formats, implementing traffic light systems that use green, yellow, and red indicators to represent acceptable, marginal, and inadequate performance levels for different CPR parameters. The feedback module may create animated feedback displays that demonstrate proper technique corrections through visual guides, target zones, and/or movement trajectories overlaid on live video feeds from the capturing device 102, utilizing augmented reality techniques to superimpose corrective guidance directly onto the trainee's 114 view of the training area with spatially accurate positioning cues and technique demonstrations.

The feedback module may implement personalized feedback generation algorithms that customize the content, tone, and complexity of performance feedback based on the individual characteristics and learning needs of each trainee 114. The feedback module may analyze the trainee's 114 historical performance data, experience level, learning preferences, and/or improvement patterns to generate tailored coaching messages that address specific performance weaknesses identified in the analysis results and reinforce successful techniques. The feedback module may implement adaptive language processing that adjusts the technical complexity and instructional detail of feedback content based on the trainee's 114 medical background, training objectives, and/or comprehension level, utilizing natural language generation techniques to create conversational feedback that explains performance issues in accessible terms and provides step-by-step improvement guidance. The feedback module may implement motivational feedback strategies that balance constructive criticism with positive reinforcement to maintain trainee 114 engagement and confidence throughout the learning process.

As shown in FIG. 3, the feedback module may perform step 318 by implementing comprehensive feedback reporting capabilities that generate detailed performance summaries and improvement recommendations based on the analysis results. The feedback module may create structured feedback reports that categorize performance issues by type, severity, and frequency, providing the trainee 114 with clear understanding of their technique strengths and areas requiring improvement. The feedback module may generate trend analysis reports that track performance changes over multiple training sessions, highlighting progress patterns and identifying persistent technique problems that may require focused attention. The feedback module may implement comparative feedback features that benchmark the trainee's 114 performance against established CPR guidelines, peer performance data, and/or expert technique standards, providing context for individual achievement levels and creating personalized training plans that recommend specific exercises, practice routines, and/or skill development activities based on the identified performance gaps and learning objectives.

The feedback module may incorporate interactive feedback features that enable the trainee 114 to engage with performance data and request additional guidance through the mobile application 106. The feedback module may implement question-and-answer interfaces that allow the trainee 114 to seek clarification about specific feedback points, technique recommendations, and/or performance metrics, and provide interactive replay capabilities that enable the trainee 114 to review specific portions of their CPR performance with synchronized feedback annotations and corrective guidance. The feedback module may implement gamification elements such as achievement badges, progress levels, and/or skill challenges that motivate continued learning and technique improvement, and enable social feedback features that allow the trainee 114 to share performance achievements, seek peer advice, and/or participate in collaborative learning activities through the mobile application 106.

The feedback module may implement multi-sensory feedback delivery mechanisms that engage multiple sensory channels to enhance learning effectiveness and technique retention. The feedback module may generate haptic feedback through vibration patterns, force feedback, and/or tactile cues delivered through wearable devices, mobile devices, and/or specialized training equipment connected to the system 100. The feedback module may create audio feedback that includes spoken instructions, performance alerts, compression timing cues, and/or ambient sound effects that reinforce proper technique patterns, and utilize visual feedback through dynamic displays, color changes, animation sequences, and/or lighting effects that provide immediate performance indication without disrupting the trainee's 114 focus on the CPR exercise. The feedback module may implement synchronized multi-modal feedback that coordinates visual, audio, and haptic cues to create immersive learning experiences that engage multiple learning pathways simultaneously.

The feedback module may incorporate adaptive feedback intensity and complexity management that adjusts the level of guidance provided based on the trainee's 114 skill development and learning progress over multiple training sessions. The feedback module may implement progressive feedback reduction that gradually decreases the frequency and detail of performance prompts as the trainee 114 demonstrates improved technique consistency and competency, utilizing skill-based feedback scaling that provides detailed, step-by-step guidance for novice trainees 114 while offering more advanced performance analytics and subtle technique refinements for experienced practitioners. The feedback module may implement context-sensitive feedback that adjusts the type and timing of performance guidance based on the specific phase of the CPR training session, such as initial positioning, active compression cycles, and/or technique review periods, and enable instructor-controlled feedback customization that allows certified CPR instructors to modify feedback parameters, set performance thresholds, and/or override automated feedback decisions based on individual trainee 114 needs and training objectives.

The feedback module may incorporate longitudinal feedback tracking capabilities that monitor and report on the trainee's 114 skill development and performance improvement over extended periods and multiple training sessions. The feedback module may generate progress tracking reports that document technique improvements, skill milestones, and/or competency achievements across weeks, months, and/or years of training activity, implementing performance trend analysis that identifies patterns of improvement, skill plateaus, and/or technique regressions that may require adjusted training approaches and/or additional instruction. The feedback module may utilize predictive feedback algorithms that forecast future performance outcomes based on current learning trajectories and provide proactive recommendations for skill maintenance and continued development, and implement certification tracking features that monitor the trainee's 114 progress toward CPR certification requirements and provide feedback on readiness for formal assessment and/or skill validation.

Referring to FIG. 3, the feedback module may perform step 318 by implementing evidence-based feedback content that incorporates current medical research, clinical guidelines, and/or best practices established by professional organizations such as the American Heart Association and European Resuscitation Council. The feedback module may access databases of CPR research findings, clinical studies, and/or expert recommendations to ensure that performance feedback reflects the most current understanding of effective resuscitation techniques, implementing guideline-compliant feedback that aligns performance assessments and improvement recommendations with established CPR protocols and certification standards. The feedback module may utilize meta-analysis data and clinical outcome studies to prioritize feedback content based on the relative importance of different technique parameters for patient survival and resuscitation success, and implement dynamic guideline integration that automatically updates feedback criteria and recommendations when new CPR protocols and/or research findings become available.

The feedback module may incorporate accessibility features and inclusive design principles that ensure performance feedback remains effective for trainees 114 with diverse abilities, learning preferences, and/or technological familiarity. The feedback module may implement visual accessibility features such as high-contrast displays, adjustable font sizes, color-blind friendly palettes, and/or screen reader compatibility for trainees 114 with visual impairments, audio accessibility options such as voice-controlled interfaces, audio descriptions of visual feedback elements, and/or customizable audio alert systems for trainees 114 with hearing impairments, and motor accessibility features such as simplified touch interfaces, voice activation, and/or alternative input methods for trainees 114 with limited mobility and/or dexterity. The feedback module may provide cognitive accessibility support through simplified language options, visual learning aids, step-by-step instruction breakdowns, and/or memory assistance features that accommodate different learning abilities and processing speeds.

The feedback module may implement performance feedback archiving and retrieval capabilities that enable the trainee 114 to access historical feedback data, review past performance assessments, and/or track long-term skill development through the mobile application 106. The feedback module may create searchable feedback databases that allow the trainee 114 to locate specific performance topics, technique guidance, and/or improvement recommendations from previous training sessions, implement feedback export features that enable the trainee 114 to share performance data with instructors, supervisors, and/or certification bodies as required for training documentation and/or professional development records, and provide feedback synchronization capabilities that maintain consistent performance data across multiple devices, platforms, and/or training locations used by the trainee 114. The feedback module may implement privacy-controlled feedback sharing that allows the trainee 114 to selectively share performance achievements, improvement milestones, and/or technique demonstrations with chosen individuals and/or training communities while maintaining control over personal performance data.

Embodiments of the present invention may be evaluated through various testing methodologies and usage scenarios to assess the accuracy of compression detection, posture analysis, and overall CPR performance evaluation. The performance benchmarks described below represent illustrative examples of capabilities that may be achieved by the processing pipeline using pose estimation models and analysis algorithms, and are not intended to limit the scope of the present invention.

In some embodiments, the system 100 may achieve compression detection accuracy exceeding 95% in identifying valid compression cycles from recorded video based on manual ground-truth annotation. False positive rates may be maintained below 3%, primarily resulting from non-CPR movements such as body sway or arm shifts. Various embodiments of the system 100 may implement minimum cycle separation of 0.6 seconds between compressions to prevent duplicate counting and ensure accurate cycle identification, although other separation thresholds may be utilized in different implementations.

In some cases, compression depth estimation may achieve accuracy within ±2 mm when validated against known object deformation characteristics. Embodiments of the system 100 may provide depth resolution sensitive to less than 5 pixel vertical changes, with measurements smoothed using moving average filters with configurable window sizes. Depth calculations may be calibrated using anthropometric scaling factors to convert pixel-based measurements into real-world distance values, though various calibration methods may be employed in different embodiments.

In some embodiments, posture evaluation accuracy may achieve 93% correct classification for elbow lock detection within the 165-180 degree range, 90% detection accuracy for hand-to-back angle measurements within the 80-100 degree range, and/or 91% detection rate for pushing perpendicularity relative to vertical axis. Symmetry and lateral drift detection may operate within ±10 pixel tolerance levels to identify hand positioning deviations, though other tolerance levels may be implemented in various embodiments of the present invention.

System robustness may be maintained through frame validation processes that exclude frames where body keypoints are missing or landmark visibility falls below certain confidence thresholds, such as 0.7 in some implementations. Embodiments of the system 100 may operate across front and side camera views, with various results achieved depending on the available viewing angles. In some cases, automatic session rejection may occur when full upper body detection is not achieved during positioning phases, though other validation criteria may be employed in different embodiments.

In some embodiments, session-level scoring accuracy may demonstrate 96% consistency between automated assessment scores and expert human evaluation. Rate deviation detection outside certain ranges, such as 100-120 compressions per minute in some implementations, may be flagged in test cases. Posture faults including bent elbows and off-angle arm positioning may be flagged in test sessions. Depth errors may be identified when measurements fall below certain thresholds, such as approximately 5 cm or scaled object depth equivalents in some embodiments, though these thresholds may vary across different implementations of the present invention.

Processing performance may achieve various processing times for video analysis in different implementations, such as 5-7 seconds per 60-second video in some cloud-based implementations, including landmark detection, metrics calculation, and video overlay rendering. Embodiments of the system 100 may support standard mobile camera recordings at various frame rates, such as 30 frames per second, and maintain operation across various smartphone hardware configurations. Real-time processing capabilities may be achieved with different latency targets in various embodiments, such as 200 milliseconds or less for pose estimation, signal smoothing, and overlay rendering operations in some implementations. These performance metrics are provided as illustrative examples only and are not intended to limit the scope of the present invention.

Embodiments of the system 100 may operate in various processing modes to accommodate different deployment scenarios, technical requirements, and user preferences. The system 100 may implement post-recording processing architectures, real-time processing capabilities, and/or hybrid approaches that combine elements of both modes, providing flexibility across different hardware platforms, network environments, and application requirements while maintaining assessment accuracy.

In some embodiments, the system 100 may operate in a post-recording processing mode where video capture and analysis occur sequentially. The capturing device 102 may record the complete CPR training session and store the video locally before transmitting it to the central server 104 for analysis. This architecture may provide advantages including consistent processing quality independent of real-time constraints, application of computationally intensive algorithms, and reliable operation across varying network conditions and device capabilities.

The post-recording workflow may include sequential phases that optimize analysis quality and system reliability. During session initiation, the trainee 114 may access the mobile application 106 and receive positioning instructions through the user interface 106a. The capturing device 102 may provide guidance to help the trainee 114 achieve proper positioning relative to the training dummy 112, using on-screen guidelines to ensure optimal video capture. Recording may begin automatically after a positioning validation period, typically 60 seconds, during which the system 100 verifies proper positioning.

Following recording completion, the upload phase may transmit the video from the capturing device 102 to the central server 104 through the wireless communication network 108. The video may be compressed to optimize transmission while preserving visual quality for accurate analysis. Upload requirements typically include 10-15 megabytes for a 60-second session. The system 100 may implement resumable upload protocols to handle network interruptions and ensure reliable transmission under challenging connectivity conditions.

The processing phase may occur on the central server 104 after successful upload, utilizing cloud-based infrastructure for comprehensive analysis. The preprocessing module 104a, marking module 104b, computing module 104c, classification module 104d, editor module 104e, and analysis module 104f may operate sequentially to generate assessments and feedback videos. Processing times may range from 5-7 seconds per 60-second video, including landmark detection, metrics calculation, and overlay rendering. The central server 104 may utilize parallel processing and optimized algorithms to minimize latency while maintaining accuracy.

The result delivery phase may return the processed results and feedback video to the mobile application 106 for presentation to the trainee 114. Feedback may include annotated video with performance overlays, numerical metrics, deviation analysis, and improvement recommendations. The mobile application 106 may cache results locally on the computing device 110 for offline review. The complete post-recording workflow may typically require 1-2 minutes from upload completion to result delivery, depending on server load and processing complexity.

Embodiments of the system 100 may support real-time processing capabilities for immediate feedback during live CPR training sessions. Real-time processing may provide instantaneous assessment and corrective guidance while the trainee 114 performs compressions, allowing for immediate technique corrections. This architecture may utilize optimized algorithms, efficient processing pipelines, and low-latency communication protocols to minimize delay between compression detection and feedback presentation. Frame-level processing latency may be maintained at 200 milliseconds or less in some embodiments, enabling immediate visual and audio feedback that corresponds closely with the trainee's 114 movements.

Live feedback capabilities may include real-time visual indicators on the user interface 106a during compressions, providing immediate assessment of depth, hand positioning, posture, and rate. Audio feedback may include spoken instructions, timing cues, and corrective prompts that guide the trainee 114 without requiring visual attention to the computing device 110. The system 100 may generate real-time compression rate feedback by continuously monitoring timing between compression cycles and providing alerts when the rate falls outside the target range of 100-120 compressions per minute.

Real-time processing embodiments may implement on-device processing capabilities that perform analysis directly on the computing device 110 without requiring data transmission to the central server 104. On-device processing may utilize computational resources of modern mobile devices, including CPUs, GPUs, and neural processing units, to achieve real-time performance while maintaining data privacy and reducing network dependency. The mobile application 106 may incorporate optimized versions of all processing modules specifically designed for efficient execution on mobile hardware.

Hardware requirements for real-time on-device processing may include mid-range or higher ARM processors, such as Snapdragon 700 series or equivalent, to provide sufficient computational performance. The computing device 110 may include at least 4 GB of RAM to support concurrent execution of multiple processing modules. Devices with dedicated neural accelerators may offer enhanced performance for machine learning operations. The capturing device 102 may utilize standard front-facing HD cameras capable of recording at 30 fps or higher for accurate movement tracking.

Alternative real-time processing embodiments may utilize cloud-assisted processing that combines on-device preprocessing with server-based analysis to balance efficiency with accuracy. The capturing device 102 may perform initial preprocessing and pose estimation locally, transmitting only extracted landmark data and essential video segments to the central server 104 for advanced analysis. This hybrid approach may reduce bandwidth requirements while maintaining access to cloud-based infrastructure for complex operations.

Network requirements for cloud-based real-time processing may include minimum upload speeds of 2 Mbps or higher to support smooth transmission of video data. Network latency tolerance may be maintained at 500 ms or less to ensure acceptable responsiveness. The system 100 may support various connectivity options including Wi-Fi, 4G, and 5G networks, with automatic adaptation based on available bandwidth. The wireless communication network 108 may implement adaptive streaming protocols that adjust video quality and compression based on real-time network performance.

Mobile-cloud communication protocols for real-time operation may utilize optimized data transmission techniques that minimize latency while ensuring reliable delivery. The mobile application 106 may establish persistent connections with the central server 104 to reduce connection overhead and enable immediate data transmission. Streaming protocols may support bidirectional communication that allows the central server 104 to provide immediate feedback while receiving continuous input from the capturing device 102.

Real-time processing readiness may be achieved through architectural design decisions that optimize the system 100 for immediate deployment. The marking module 104b may utilize models such as BlazePose specifically designed for real-time operation on mobile platforms. The computing module 104c may implement algorithms optimized for frame-by-frame processing with minimal computational overhead. The editor module 104e may utilize OpenCV-based rendering techniques that support real-time overlay generation without significant delays.

Embodiments of the system 100 may implement adaptive processing modes that automatically select between post-recording and real-time processing based on device capabilities, network conditions, and user preferences. The mobile application 106 may assess computational performance, network bandwidth, and battery life to determine the optimal processing mode for each session. Manual mode selection may also be provided through the user interface 106a for advanced users with specific training requirements.

Embodiments of the present invention may provide numerous advantages and technical benefits. In some cases, embodiments of the present invention may ameliorate one or more problems of the prior art or at least provide a useful alternative. Various embodiments may automate the assessment of CPR performance through video analysis, providing a system for assessing cardiopulmonary resuscitation (CPR) performance based on training feedback.

Embodiments of the present invention may provide real-time feedback to trainees on their CPR performance, which may enhance training effectiveness. In some cases, embodiments may ensure consistent evaluation across different training sessions and trainees. Some embodiments may offer broader accessibility and scalability, particularly in remote or resource-limited settings, while providing remote accessibility. Various embodiments may be less costly compared to traditional CPR training systems that require expensive mannequins.

Embodiments of the present invention may generate detailed analysis reports highlighting deviations from standard CPR guidelines. In some cases, embodiments may offer comprehensive, real-time, and cost-effective assessment of CPR performance, integrating advanced video analysis and machine learning technologies. Various embodiments may provide corrective analysis trends and patterns to help trainees improve their CPR techniques over time.

The technical advantages of embodiments described herein may include, but are not limited to, providing accurate and objective assessments of CPR performance. In some cases, embodiments may reduce human bias and error in evaluating CPR technique. Various embodiments may provide immediate feedback during training sessions, enabling trainees to correct their techniques on the spot, which may enhance the learning experience by making it interactive and responsive.

Embodiments of the present invention may ensure consistent assessment criteria through standardized video processing and marking techniques. In some cases, embodiments may continuously update and improve the model based on real-time feedback and performance data. Various embodiments may ensure standardized evaluation and real-time feedback, enhancing the effectiveness of CPR training. Some embodiments may facilitate uniform training experiences across different trainees and sessions, and may classify CPR compressions accurately, leveraging vast amounts of training data.

Embodiments of the present invention may incorporate specific technical implementations that transform video data through computational processes to generate objective performance assessments. The preprocessing module 104a may apply frame rate conversion algorithms that standardize temporal resolution across different video inputs, implementing mathematical transformations that convert variable frame rates to consistent output formats suitable for pose estimation analysis. These transformations address technical challenges in video processing that cannot be performed manually and enable automated analysis across diverse capturing devices 102. The preprocessing module 104a may utilize background subtraction techniques that employ Gaussian mixture models, morphological operations, and/or other image processing methods to isolate the trainee 114 from environmental elements, creating processed video data with enhanced signal-to-noise ratios for subsequent analysis stages that would be impossible to achieve through human observation alone. In some cases, the preprocessing module 104a may process a minimum of 1,000 video frames per training session, with each frame requiring at least 500,000 computational operations for standardization, resulting in a minimum of 500 million computational operations per training session for video preprocessing alone.

The marking module 104b may implement encoder-decoder neural network architectures with skip connections that process input images through convolutional layers to generate heatmap-based keypoint localizations. This computational approach solves the technical problem of accurately identifying anatomical landmarks in video data at a scale and precision beyond human capability. The marking module 104b may utilize regression CNN components that predict coordinate positions with visibility parameters for anatomical landmarks, transforming raw pixel data into structured spatial coordinate datasets that represent body positioning throughout the CPR training session. The marking module 104b may apply temporal tracking algorithms including Kalman filtering, optical flow techniques, and/or particle filtering methods that maintain consistent landmark identification across video frame sequences, generating continuous motion trajectory data that captures the dynamics of CPR compression movements with millisecond precision that would be technically impossible to achieve through manual analysis. Embodiments of the marking module 104b may utilize neural network architectures that include, at minimum: (1) at least 15 convolutional layers; (2) at least 5 million trainable parameters; (3) at least 3 skip connections between encoder and decoder components; (4) at least 10 feature channels in the initial convolutional layer; and/or (5) at least 32 feature channels in the deepest convolutional layer.

Referring to FIG. 3, the computing module 104c may perform step 306 by implementing anthropometric calibration algorithms that utilize established body segment ratios to convert pixel-based measurements into calibrated real-world distance values. These algorithms solve the technical challenge of accurate measurement without specialized hardware, representing a significant technical improvement over conventional CPR training systems. The computing module 104c may calculate compression depth parameters through coordinate transformation techniques that measure vertical displacement of hand positions relative to baseline references, applying mathematical scaling factors derived from anatomical landmark relationships to generate accurate depth measurements in standardized units. The computing module 104c may implement signal processing algorithms including moving average filters, Savitzky-Golay filters, and/or adaptive filtering methods that process raw position data to extract compression rate, timing consistency, and/or force estimation parameters with a level of precision and objectivity that fundamentally transforms CPR assessment capabilities. In some embodiments, the computing module 104c may perform a minimum of: (1) at least 100,000 coordinate transformations per minute of video analysis; (2) at least 50,000 depth calculations per training session; (3) at least 10,000 angle measurements between body segments; (4) at least 5,000 rate calculations; and/or (5) at least 2,000 force estimations based on deformation analysis.

The classification module 104d may implement convolutional neural networks trained on labeled datasets of CPR compression videos, utilizing supervised learning algorithms that extract feature representations from temporal sequences of body movement parameters. This machine learning approach enables the system 100 to perform complex pattern recognition across thousands of data points simultaneously, a computational task that would be practically impossible for human evaluators to perform with comparable accuracy or consistency. The classification module 104d may apply transfer learning techniques that adapt pre-trained pose estimation models to CPR-specific classification tasks, implementing fine-tuning algorithms that optimize network weights based on compression quality training data. The classification module 104d may generate compression classifications through multi-class prediction algorithms that evaluate individual compression cycles against established performance criteria, producing structured output data with confidence scores, quality assessments, and/or performance metrics that represent a fundamental technical advancement in CPR training assessment.

Embodiments of the classification module 104d may utilize machine learning models trained on datasets comprising, at minimum: (1) at least 10,000 labeled compression examples; (2) at least 5,000 correct compression examples; (3) at least 5,000 incorrect compression examples with various error types; (4) at least 1,000 different trainees represented in the training data; and/or (5) at least 500 different non-mannequin training objects with varying characteristics.

As shown in FIG. 3, the editor module 104e may perform steps 310 and 312 by implementing computer graphics algorithms that overlay performance metrics onto video frames through coordinate-based positioning systems. These algorithms solve the technical challenge of synchronizing analytical data with visual content, creating integrated feedback that would be impossible to generate manually. The editor module 104e may utilize OpenCV drawing functions, graphics rendering techniques, and/or visualization libraries to embed numerical displays, progress bars, and/or color-coded annotations at specific spatial locations corresponding to anatomical landmarks. The editor module 104e may apply video encoding algorithms that compress annotated frames into standard video formats while preserving visual quality of overlaid metrics, implementing multi-threaded processing architectures that enable efficient generation of feedback videos through parallel frame processing operations that represent a significant technical improvement in computational efficiency. In some embodiments, the editor module 104e may perform a minimum of: (1) at least 30 graphical overlay operations per video frame; (2) at least 20 text rendering operations per frame for numerical metrics; (3) at least 15 shape drawing operations per frame for visual indicators; (4) at least 10 color mapping operations per frame for performance visualization; and/or (5) at least 5 animation calculations per second for dynamic feedback elements.

The analysis module 104f may implement statistical analysis algorithms that calculate deviation scores by quantifying differences between measured performance parameters and established CPR guideline benchmarks. These algorithms enable objective assessment at a scale and consistency that would be technically impossible through manual evaluation methods. The analysis module 104f may utilize time series analysis methods including trend detection, change point analysis, and/or seasonal decomposition to identify performance patterns across multiple compression cycles, generating quantitative assessments of technique consistency and quality degradation over time. The analysis module 104f may apply multivariate correlation analysis techniques that examine relationships between different body movement parameters to identify complex technique problems requiring targeted corrective instruction, representing a technical solution to the challenge of comprehensive CPR performance evaluation. Embodiments of the analysis module 104f may process, at minimum: (1) at least 100 distinct performance metrics per training session; (2) at least 50 deviation calculations per minute of training; (3) at least 25 temporal pattern analyses across compression sequences; (4) at least 20 correlation calculations between different body movement parameters; and/or (5) at least 10 trend analyses for performance consistency evaluation.

Embodiments of the system 100 may implement real-time processing capabilities through optimized computational architectures that minimize latency between video capture and feedback delivery, achieving frame-level processing latency targets of 200 milliseconds or less in some embodiments. The system 100 may utilize hardware acceleration techniques including GPU processing, specialized neural network processors, and/or distributed computing resources to achieve frame rates suitable for live performance assessment during CPR training sessions. These technical implementations enable immediate feedback that fundamentally transforms the CPR training process compared to conventional methods. The system 100 may implement streaming data processing pipelines that analyze video content incrementally as frames become available, enabling immediate technique correction guidance without waiting for complete compression cycle completion, a technical capability that addresses the specific challenge of providing actionable feedback during time-critical medical training. In some embodiments, the real-time processing pipeline may handle, at minimum: (1) at least 25 frames per second of video input; (2) at least 15 pose estimations per second; (3) at least 10 compression classifications per second; (4) at least 5 feedback generation operations per second; and/or (5) at least 3 deviation analyses per second with latency under 200 milliseconds, while maintaining compression detection accuracy exceeding 95% and depth estimation precision within ±2 mm in some embodiments.

The system 100 may incorporate machine learning model adaptation algorithms that continuously refine classification accuracy based on feedback from trainees 114 and instructors. This adaptive learning capability represents a technical improvement that enables the system 100 to evolve and improve over time, addressing the challenge of maintaining assessment accuracy across diverse training scenarios. The system 100 may implement online learning techniques that update model parameters based on new training data collected during CPR sessions, utilizing incremental training methods that improve performance assessment capabilities over time. The system 100 may apply ensemble learning approaches that combine predictions from multiple neural network architectures to enhance classification robustness and accuracy across diverse training scenarios, trainee 114 characteristics, and/or environmental conditions, representing a sophisticated computational solution to the technical challenge of reliable CPR technique assessment. Embodiments of the adaptive learning system may utilize, at minimum: (1) at least 3 different neural network architectures in ensemble configurations; (2) at least 1,000 training examples per incremental update cycle; (3) at least 500 gradient descent iterations per model update; (4) at least 100 hyperparameter combinations evaluated during optimization; and/or (5) at least 50 cross-validation folds for robustness evaluation during model refinement.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Embodiments of the system 100 may implement various network communication architectures to support different processing modes and deployment requirements. For post-recording processing embodiments, the wireless communication network 108 may utilize standard internet protocols and secure transmission methods to upload recorded video content to the central server 104. Network requirements may include sufficient bandwidth to support video file transmission, with typical requirements ranging from 1 to 5 megabits per second depending on video quality settings and compression algorithms. The system 100 may implement adaptive upload strategies that adjust transmission parameters based on available bandwidth and connection stability to optimize upload reliability and completion times.

Real-time processing embodiments may utilize low-latency communication protocols that minimize the delay between data transmission and response delivery. The mobile application 106 may establish WebSocket connections, real-time transport protocol streams, or similar low-latency communication channels with the central server 104 to enable immediate bidirectional data exchange. Network latency requirements may be maintained below 100 milliseconds, 200 milliseconds, 300 milliseconds, or 500 milliseconds in various embodiments to ensure responsive real-time feedback delivery. The system 100 may implement network quality monitoring that continuously assesses connection performance and automatically adjusts processing strategies to maintain optimal user experience under varying network conditions.

Data security and privacy considerations may be implemented across all processing modes to protect trainee 114 information and training session data. The wireless communication network 108 may utilize encrypted transmission protocols such as HTTPS, TLS, or similar security standards to protect data during transmission between the capturing device 102 and central server 104. On-device processing embodiments may provide enhanced privacy protection by maintaining all analysis data locally on the computing device 110 without requiring external data transmission. Hybrid processing approaches may implement selective data transmission that sends only essential analysis parameters to external servers while retaining sensitive video content on the local device.

Performance optimization techniques may be implemented to enhance the efficiency and reliability of both post-recording and real-time processing modes. The system 100 may utilize computational resource management algorithms that allocate processing power dynamically based on current system load and performance requirements. Battery life optimization may be implemented for mobile devices through adaptive processing intensity, selective feature activation, and efficient algorithm selection based on remaining battery capacity. Thermal management may monitor device temperature and adjust processing parameters to prevent overheating during extended training sessions or intensive real-time analysis operations.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

Unless expressly and specifically stated otherwise in this specification, the omission from this specification of any subject matter, terminology, embodiments, examples, features, elements, steps, or other content that was disclosed in any application to which this application claims priority (including, but not limited to, any provisional application) is not intended to disclaim, surrender, or narrow the scope of any claim term herein. Such omissions are made solely for purposes of brevity, clarity, organization, or drafting preference and shall not be construed as evidencing any intent by the applicant to limit, restrict, or abandon any aspect of the claimed invention or to exclude any interpretation that would otherwise be available based on the incorporated subject matter. The applicant specifically reserves the right to claim the full scope of any invention disclosed in any application incorporated herein by reference or otherwise whose priority or benefit is claimed, whether or not such invention is explicitly redescribed in this specification. Any construction of claim terms should consider the full scope of disclosure available in this specification together with all incorporated applications, and no negative inference should be drawn from any omission of previously disclosed subject matter unless such limitation is expressly and unambiguously set forth in this specification.

What is claimed is:

1. A system for training, assessing, and providing feedback on cardiopulmonary resuscitation (CPR) performance based on at least one video of a CPR training session performed by a trainee on a non-mannequin training object, the system comprising:
a preprocessing module configured to process the at least one video to generate a standardized video;
a marking module configured to use pose estimation to mark points for body movements during the CPR training session based on the standardized video;
a computing module configured to compute body movement parameters for CPR, based on the marked points;
a classification module configured to implement a machine learning model that classifies CPR compressions on the non-mannequin training object based on the computed body movement parameters, thereby generating compression classifications, wherein the machine learning model is trained to extract CPR-specific features;
an editor module configured to:
map metrics over the standardized video based on the compression classifications; and
generate a feedback video based on the mapped metrics; and
an analysis module configured to:
identify, based on the feedback video, deviations from CPR guidelines; and
generate analysis results based on the deviations; and
a feedback module configured to provide performance feedback to the trainee based on the analysis results.

2. The system of claim 1, wherein the non-mannequin training object comprises a partially filled bottle, and wherein the preprocessing module is configured to detect a fill level of the partially filled bottle.

3. The system of claim 1, wherein the preprocessing module is configured to apply frame rate conversion to the at least one video to generate the standardized video with a consistent frame rate.

4. The system of claim 1, wherein the marking module is configured to identify key anatomical landmarks including at least one of shoulder joints, elbow joints, wrist joints, hip position, leg position, back position, or hand positions of the trainee.

5. The system of claim 1, wherein the marking module is configured to identify compression cycles by detecting periodic patterns in the marked point movements.

6. The system of claim 1, wherein the marking module is configured to mark additional reference points on the non-mannequin training object to establish spatial relationships for depth measurements.

7. The system of claim 1, wherein the computing module is configured to calculate compression depth by measuring vertical displacement of hand positions relative to a baseline position on the non-mannequin training object.

8. The system of claim 1, wherein the computing module is configured to determine compression rate by counting the number of compression cycles per minute based on the marked points.

9. The system of claim 1, wherein the computing module is configured to determine compression release completeness by analyzing the return trajectory of hand positions between compression cycles.

10. The system of claim 1, wherein the computing module is configured to compute body posture metrics by analyzing alignment of shoulder, hip, and knee joint positions relative to the non-mannequin training object.

11. The system of claim 1, wherein the classification module is configured to implement a convolutional neural network trained on a dataset of labeled CPR compression videos to distinguish between correct and incorrect compression techniques.

12. The system of claim 1, wherein the classification module is configured to classify compressions into multiple categories including at least two of adequate depth, inadequate depth, correct hand placement, incorrect hand placement, proper release, correct posture, incorrect posture, correct compression rate, incorrect compression rate, or incomplete release.

13. The system of claim 1, wherein the classification module is configured to adapt the machine learning model based on real-time feedback from the trainee to personalize the classification criteria.

14. The system of claim 1, wherein the classification module is configured to generate intermediate classifications for individual compression components and combine them to produce an overall compression quality score.

15. The system of claim 1, wherein the editor module is configured to overlay visual indicators on the feedback video to highlight correct and incorrect compression techniques in real-time.

16. The system of claim 1, wherein the analysis module is configured to calculate deviation scores by quantifying differences between the trainee's performance and established CPR guideline benchmarks for each body movement parameter.

17. A method for training, assessing, and providing feedback on cardiopulmonary resuscitation (CPR) performance based on at least one video of a CPR training session performed by a trainee on a non-mannequin training object, the method comprising:
processing the at least one video to generate a standardized video;
using pose estimation to mark points for body movements during the CPR training session based on the standardized video;
computing body movement parameters for CPR based on the marked points;
using a machine learning model to classify CPR compressions on the non-mannequin training object based on the computed body movement parameters, thereby generating compression classifications, including extracting CPR-specific features;
mapping metrics over the standardized video based on the compression classifications;
generating a feedback video based on the mapped metrics;
identifying, based on the feedback video, deviations from CPR guidelines;
generating analysis results based on the deviations; and
providing performance feedback to the trainee based on the analysis results.

18. The method of claim 17, wherein the non-mannequin training object comprises a partially filled bottle, and wherein processing the at least one video includes detecting a fill level of the partially filled bottle.

19. The method of claim 17, wherein using the machine learning model to classify CPR compressions further comprises using the machine learning model to classify compressions into multiple categories including at least two of adequate depth, inadequate depth, correct hand placement, incorrect hand placement, proper release, correct posture, incorrect posture, correct compression rate, incorrect compression rate, or incomplete release.

20. The method of claim 17, further comprising adapting the machine learning model based on real-time feedback from the trainee to personalize the classification criteria.
